(19) United States
(12) Patent Application Publication
(10) Pub. No.: US 2015/0208001 A1
(43) Pub. Date: Jul. 23, 2015

(54) IMAGING DEVICE, IMAGING METHOD, AND PROGRAM

(71) Applicant: OLYMPUS CORPORATION, Tokyo (JP)

(72) Inventors: Tetsuya KANEKO, Tokyo (JP); Osamu NONAKA, Sagamihara-shi (JP)

(73) Assignee: OLYMPUS CORPORATION, Tokyo (JP)

(21) Appl. No.: 14/615,863

(22) Filed: Feb. 6, 2015

Related U.S. Application Data
(63) Continuation of application No. PCT/JP2014/065384, filed on Jun. 10, 2014.

(30) Foreign Application Priority Data
Sep. 3, 2013 (JP) 2013-182553

(51) Int. Cl. H04N 5/262; H04N 5/232; G06T 5/00; G06T 7/00

(52) U.S. Cl. CPC H04N 5/2621; G06T 7/0085; H04N 5/23225; G06T 5/002; H04N 5/23212; G06T 2207/10004; G06T 2207/20116

(57) ABSTRACT

An imaging device includes: an imaging unit configured to image an object and generate image data of the object; a contour detector configured to detect a contour of the object in an image corresponding to the image data generated by the imaging unit; a special effect processor configured to generate processed image data that produces a visual effect by performing different image processing for each object area determined by a plurality of contour points that constitutes a contour of the object in accordance with a perspective distribution of the plurality of the contour points that constitutes the contour of the object from the imaging unit, the image processing being performed on an area surrounded by the contour in the image corresponding to the image data generated by the imaging unit.

### CROSS REFERENCES TO RELATED APPLICATIONS

This application is a continuation of PCT international application Ser. No. PCT/JP2014/065384 filed on Jun. 10, 2014 which designates the United States, incorporated herein by reference, and which claims the benefit of priority from Japanese Patent Applications No. 2013-182553, filed on Sep. 3, 2013, incorporated herein by reference.

### BACKGROUND OF THE INVENTION

1. Field of the Invention

The present invention relates to an imaging device, an imaging method, and a program, which image an object and generate image data of the object.

2. Description of the Related Art

In recent years, a technique is known in which different image processing operations are performed on an object and a background respectively in an imaging device such as a digital camera (see Japanese Laid-open Patent Publication No. 2013-3990). In this technique, areas of the object and the background are respectively extracted by performing edge detection processing for detecting an edge of an image and different image processing operations are performed on the extracted areas of the object and the background, respectively.

However, in Japanese Laid-open Patent Publication No. 2013-3990 described above, different image processing operations can be performed only on the areas of the object and the background, respectively. Therefore, for a variety of representation of an image, a technique is desired which can perform image processing with richer expression using abundant image information.

### SUMMARY OF THE INVENTION

An imaging device according to one aspect of the present invention includes: an imaging unit configured to image an object and generate image data of the object; a contour detector configured to detect a contour of the object in an image corresponding to the image data generated by the imaging unit; a special effect processor configured to generate processed image data that produces a visual effect by performing different image processing for each object area determined by a plurality of contour points that constitutes a contour of the object in accordance with a perspective distribution of the plurality of the contour points that constitutes the contour of the object from the imaging unit, the image processing being performed on an area surrounded by the contour in the image corresponding to the image data generated by the imaging unit.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a configuration of an imaging device according to a first embodiment of the present invention on the side facing an object;

FIG. 2 is a perspective view illustrating a configuration of the imaging device according to the first embodiment of the present invention on the side facing a person who captures an image;

FIG. 3 is a block diagram illustrating a functional configuration of the imaging device according to the first embodiment of the present invention;

FIG. 4 is a diagram illustrating an overview of special effect processing performed by a special effect processing unit of the imaging device according to the first embodiment of the present invention;

FIG. 5 is a flowchart illustrating an overview of processing executed by the imaging device according to the first embodiment of the present invention;

FIG. 6 is a diagram illustrating an example of an image displayed by a display unit of the imaging device according to the first embodiment of the present invention;

FIG. 7 is a flowchart illustrating an overview of distance art processing in FIG. 5;

FIG. 8 is a schematic diagram illustrating an overview of a determination method for determining shapes of objects whose distances are different from each other, by a shape determination unit of the imaging device according to the first embodiment of the present invention;

FIG. 9 is a diagram illustrating an example of an image determined by the shape determination unit of the imaging device according to the first embodiment of the present invention;

FIG. 10 is a diagram illustrating an example of an image corresponding to processed image data generated by the special effect processing unit of the imaging device according to the first embodiment of the present invention;

FIG. 11 is a diagram illustrating an example of an image corresponding to another processed image data generated by the special effect processing unit of the imaging device according to the first embodiment of the present invention;

FIG. 12 is a schematic diagram illustrating a situation of selecting an object through a touch panel of the imaging device according to the first embodiment of the present invention;

FIG. 13 is a block diagram illustrating a functional configuration of an imaging device according to a second embodiment of the present invention;

FIG. 14 is a flowchart illustrating an overview of distance art processing executed by the imaging device according to the second embodiment of the present invention;

FIG. 15 is a diagram illustrating an example of an image on which characters are superimposed by a special effect processing unit of the imaging device according to the second embodiment of the present invention;

FIG. 16 is a schematic diagram illustrating an overview of a method of assigning characters when the characters are superimposed in a contour of an object by the special effect processing unit of the imaging device according to the second embodiment of the present invention;

FIG. 17 is a schematic diagram illustrating adjustment of the sizes of characters performed by the special effect processing unit of the imaging device according to the second embodiment of the present invention;

FIG. 18 is a diagram illustrating an example of an image corresponding to processed image data generated by the special effect processing unit of the imaging device according to the second embodiment of the present invention;

FIG. 19 is a block diagram illustrating a functional configuration of an imaging device according to a third embodiment of the present invention;

FIG. 20 is a flowchart illustrating an overview of distance art processing executed by the imaging device according to the third embodiment of the present invention;

FIG. 21 is a series of schematic diagrams illustrating an overview of a determination method for determining an area sandwiched by peaks of contrast, by an area determination unit of the imaging device according to the third embodiment of the present invention;

FIG. 22 is a diagram illustrating an example of an image corresponding to processed image data generated by a special effect processing unit of the imaging device according to the third embodiment of the present invention;

FIG. 23A is a series of schematic diagrams illustrating an overview of a determination method for determining an area sandwiched by peaks of contrast in a slide direction, by the area determination unit of the imaging device according to the third embodiment of the present invention;

FIG. 23B is a series of schematic diagrams illustrating an overview of the determination method for determining an area sandwiched by peaks of contrast in a slide direction, by the area determination unit of the imaging device according to the third embodiment of the present invention;

FIG. 23C is a series of schematic diagrams illustrating an overview of the determination method for determining an area sandwiched by peaks of contrast in a slide direction, by the area determination unit of the imaging device according to the third embodiment of the present invention;

FIG. 24 is a diagram illustrating an example of an image corresponding to another processed image data generated by the special effect processing unit of the imaging device according to the third embodiment of the present invention;

FIG. 25 is a flowchart illustrating an overview of distance art processing executed by the imaging device according to a fourth embodiment of the present invention;

FIG. 26 is a series of diagrams illustrating an example of an image corresponding to processed image data generated by a special effect processing unit of the imaging device according to the fourth embodiment of the present invention;

FIG. 27 is a block diagram illustrating a functional configuration of an imaging device according to a fifth embodiment of the present invention; and

FIG. 28 is a flowchart illustrating an overview of processing executed by the imaging device according to the fifth embodiment of the present invention.

### DETAILED DESCRIPTION OF THE PREFERRED EMBODIMENTS

### First Embodiment

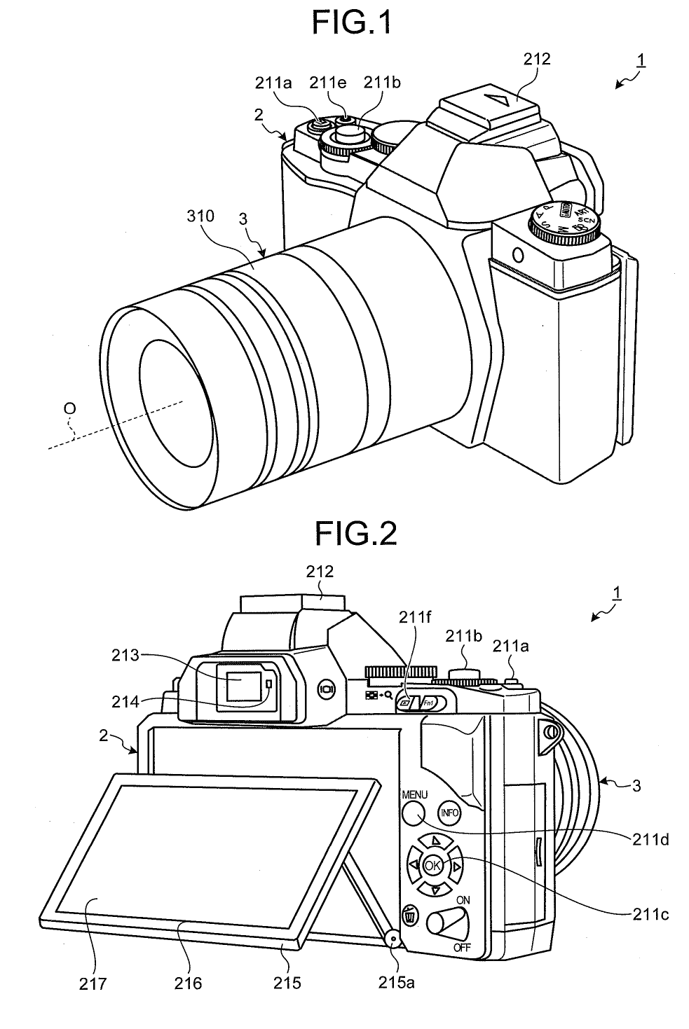

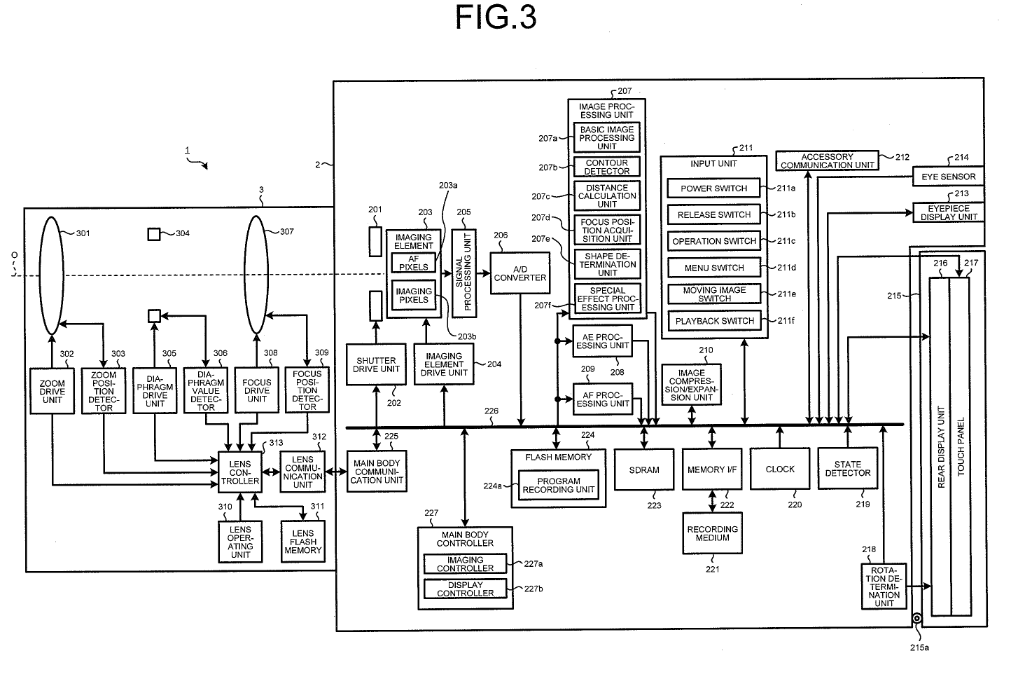

FIG. 1 is a perspective view illustrating a configuration of an imaging device according to a first embodiment of the present invention on the side (front side) facing an object. FIG. 2 is a perspective view illustrating a configuration of the imaging device according to the first embodiment of the present invention on the side (rear side) facing a person who captures an image. FIG. 3 is a block diagram illustrating a functional configuration of the imaging device according to the first embodiment of the present invention.

An imaging device 1 illustrated in FIGS. 1 to 3 includes a main body unit 2 and an optically zoomable lens unit 3 which is attachable/detachable to the main body unit 2 and which forms an image of an object.

First, the main body unit 2 will be described. The main body unit 2 includes a shutter 201, a shutter drive unit 202, an imaging element 203, an imaging element drive unit 204, a signal processing unit 205, an A/D converter 206, an image processing unit 207, an AE processing unit 208, an AF processing unit 209, an image compression/expansion unit 210, an input unit 211, an accessory communication unit 212, an eyepiece display unit 213, an eye sensor 214, a movable unit 215, a rear display unit 216, a touch panel 217, a rotation determination unit 218, a state detector 219, a clock 220, a recording medium 221, a memory I/F 222, a Synchronous Dynamic Random Access Memory (SDRAM) 223, a flash memory 224, a main body communication unit 225, a bus 226, and a main body controller 227.

The shutter 201 sets a state of the imaging element 203 to an exposed state or a light shielding state. The shutter 201 is configured by using a mechanical shutter such as a focal plane shutter.

The shutter drive unit 202 drives the shutter 201 according to an instruction signal inputted from the main body controller 227. The shutter drive unit 202 is configured by using a stepping motor, a DC motor, and the like.

The imaging element 203 is configured by using a Complementary Metal Oxide Semiconductor (CMOS) or the like in which a plurality of pixels that outputs an electrical signal by receiving light collected by the lens unit 3 and performing photoelectric conversion are two-dimensionally arranged. The imaging element 203 continuously generates image data at a predetermined frame rate, for example, at 30 fps and outputs the image data to the signal processing unit 205 under control of the main body controller 227. The imaging element 203 includes AF pixels 203a (focus detection pixel) that generate a focus signal (hereinafter referred to as “focus data”) used when the imaging device 1 performs distance measurement processing that detects a value related to a distance to an object by a phase difference detection method and image plane phase difference AF processing that adjusts a focal point of the lens unit 3 and imaging pixels 203b that receive light of an object image on an imaging plane and generate an electrical signal (hereinafter referred to as “image data”).

The AF pixels 203a are configured by using a photodiode, an amplifier circuit, and the like and provided in the imaging plane of the imaging element 203 at predetermined intervals and in a predetermined area. For example, the AF pixels 203a are provided at predetermined intervals in an AF area or a central area in a light receiving plane of the imaging element 203.

The imaging pixel 203b is configured by using a photodiode, an amplifier circuit, and the like. The imaging pixel 203b generates image data by receiving light of an object image entering from the lens unit 3 and performing photoelectric conversion.

The imaging element drive unit 204 causes the imaging element 203 to output image data (analog signal) and focus data (analog signal) to the signal processing unit 205 at a predetermined timing. In this sense, the imaging element drive unit 204 functions as an electronic shutter.

The signal processing unit 205 performs analog processing on the image data and the focus data inputted from the imaging element 203 and outputs the image data and the focus data to the A/D converter 206. For example, the signal processing unit 205 shapes the waveform of the image data after reducing reset noise and the like and then performing a gain up to obtain desired brightness.

The A/D converter 206 generates digital image data (raw data) and digital focus data by performing A/D conversion on the analog image data and the analog focus data inputted from the signal processing unit 205 and outputs the digital image data and the digital focus data to the SDRAM 223 through the bus 226. In the first embodiment, the imaging element 203, the signal processing unit 205, and the A/D converter 206 function as an imaging unit.

The image processing unit 207 includes a basic image processing unit 207a, a contour detector 207b, a distance calculation unit 207c, a focus position acquisition unit 207d, a shape determination unit 207e, and a special effect processing unit 207f.

The basic image processing unit 207a acquires the image data (raw data) from the SDRAM 223 through the bus 226 and performs various image processing on the acquired image data. Specifically, the image processing unit 207 performs basic image processing including optical black subtraction processing, white balance (WB) adjustment processing, color matrix calculation processing, gamma correction processing, color reproduction processing, and edge enhancement processing. For example, the basic image processing unit 207a performs image processing based on preset parameters of each image processing. Here, the parameters of each image processing are values of contrast, sharpness, chroma, white balance, and gradation. When the imaging element 203 has a Bayer array, the image processing unit 207 performs synchronization processing of the image data. The image processing unit 207 outputs the processed image data to the SDRAM 223 or the rear display unit 216 through the bus 226.

The contour detector 207b detects a contour of an object in an image corresponding to the image data generated by the imaging element 203. Specifically, the contour detector 207b detects a plurality of contour points that constitutes the contour (contrast) of the object by extracting luminance components of the image data and calculating second derivative absolute values of the extracted luminance components. The contour detector 207b may detect the contour points that constitute the contour of the object by performing edge detection processing on the image data. Further, the contour detector 207b may detect the contour of the object in the image by using a well-known method for the image data.

The distance calculation unit 207c calculates a value related to a distance from the imaging element 203 to at least a part of the plurality of contour points that constitutes the contour of the object detected by the contour detector 207b (although the value need not be the actual distance, the value is related to the distance, so that the value may be simply referred to as “distance”). Specifically, the distance calculation unit 207c calculates a value related to a distance to at least a part of the plurality of contour points that constitutes the contour of the object detected by the contour detector 207b on the basis of the focus data generated by the AF pixels 203a. For example, the distance calculation unit 207c calculates distances from the imaging element 203 to two points of the plurality of contour points that constitutes the contour of the object detected by the contour detector 207b on the basis of the focus data generated by the AF pixels 203a. The distance calculation unit 207c may calculate each of distances from the imaging element 203 to the plurality of contour points that constitutes the contour of the object every time a focus lens 307 of the lens unit 3 is driven by Wob-drive in which the focus lens 307 reciprocates over a small distance from the focus position along an optical axis O.

The focus position acquisition unit 207d acquires the focus position of the focus lens 307 of the lens unit 3 described later. Specifically, the focus position acquisition unit 207d acquires a position on the optical axis O of the focus lens 307 detected by a focus position detector 309 of the lens unit 3 described later.

The shape determination unit 207e determines whether or not the shape of the object is the same along the optical axis O (depth direction) of the lens unit 3 on the basis of the contour of the object detected by the contour detector 207b and the distance calculated by the distance calculation unit 207c. Further, the shape determination unit 207e determines whether or not the width of the contour of the object continues within a certain range along the optical axis O of the lens unit 3.

The special effect processing unit 207f performs special effect processing that produces a visual effect by combining a plurality of types of image processing for one image data to generate processed image data. The types of image processing combined in the special effect processing are one or more of the following: blurring processing, shading addition processing, noise superimposition processing, chroma change processing, and contrast enhancement processing. The special effect processing unit 207f generates processed image data that produces a visual effect by performing different image processing for each object area determined by a plurality of contour points that constitutes an object according to a perspective distribution of a plurality of contour points that constitutes the contour of the object from the imaging element 203 on an area surrounded by the contour in an image corresponding to one image data. Here, the perspective distribution of a plurality of contour points is a distribution of distances to each of a plurality of contour points that constitutes the contour of the object (distances in a depth direction moving away from the imaging device 1 in the visual field of the imaging device 1), which are calculated by the distance calculation unit 207c. In other words, the special effect processing unit 207f generates processed image data by performing different image processing for each object area determined according to distances to each of a plurality of contour points that constitutes the contour of the object, which are calculated by the distance calculation unit 207c.

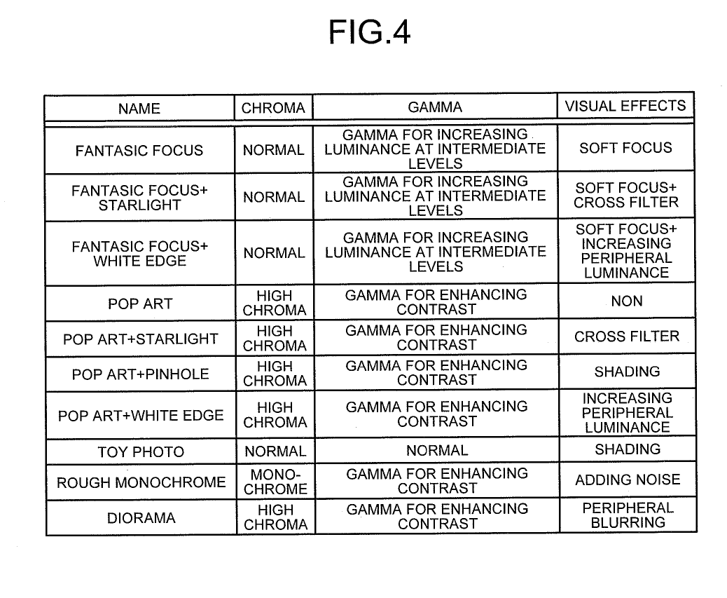

FIG. 4 is a diagram illustrating an overview of the special effect processing performed by the special effect processing unit 207f. In FIG. 4, ten types of special effect processing are described, which are fantastic focus, fantastic focus+starlight, fantastic focus+white edge, pop art, pop art+starlight, pop art+pinhole, pop art+white edge, toy photo, rough monochrome, and diorama. Hereinafter, these types of special effect processing will be described.

The fantastic focus is processing to provide a soft focus effect in which blurring processing is performed on the entire image and the blurred image and the image before blurring are synthesized at a certain ratio. The fantastic focus forms or generates an image with a beautiful and fantastic atmosphere as if being bathed in happy light while remaining details of an object in a soft tone by performing tone curve processing that increases luminance at intermediate levels. The fantastic focus is realized by combining image processing operations such as, for example, tone curve processing, blurring processing, alpha blend processing, and image synthesis processing.

The fantastic focus+starlight is processing to apply a cross filter effect that draws a cross pattern in a high luminance portion in the image in addition to the fantastic focus.

The fantastic focus+white edge is processing to apply an effect in which color becomes gradually whitish as it moves from the center portion of the image to peripheral portions (peripheral edge portions) in addition to the fantastic focus. The effect of the whitish color is obtained by changing pixel values so that the larger the distance from the center of the image is, the more white the peripheral portions are.

The pop art is processing to colorfully enhance colors to represent a cheerful and enjoyable atmosphere. The pop art is realized by combining, for example, the chroma enhancement processing and the contrast enhancement processing. The pop art produces an effect of high contrast and high chroma as a whole.

The pop art+starlight is processing in which the pop art and the starlight are superimposed and applied. In this case, an effect is obtained in which a cross filter is applied to a colorful image.

The pop art+pinhole is processing to apply toy photo (pinhole) which provides an effect as if looking into from a hole by darkening peripheral portions of an image by shading in addition to the pop art. The details of the toy photo will be described below.

The pop art+white edge is processing in which the pop art and the white edge are superimposed and applied.

The toy photo is processing which produces an effect as if looking into an unusual space from a hole and straying into the unusual space by making an image so that the larger the distance from the center of the image is, the smaller (the darker) the luminance is. The toy photo is realized by combining image processing operations such as, low-pass filter processing, white balance processing, contrast processing, hue/chroma processing, and shading processing in which the more peripheral, the smaller a coefficient by which a luminance signal is multiplied (for detailed contents of the toy photo and the shading, for example, see JP 2010-74244 A).

The rough monochrome is processing to represent forcefulness and roughness of a monochrome image by adding high contrast and granular noise of film. The rough monochrome is realized by combining edge enhancement processing, level correction optimization processing, noise pattern superimposition processing, synthesis processing, contrast processing, and the like (for detailed contents of the rough monochrome, for example, see JP 2010-62836 A). Among them, the noise pattern superimposition processing (noise addition processing) is processing to add a noise pattern image created in advance to the original image. For example, the noise pattern image may be generated based on random numbers by generating the random numbers.

The diorama is processing which creates an atmosphere as if seeing a miniature model or a toy on a screen by blurring peripheral portions (peripheral edge portions) of an image of high contrast and high chroma. The diorama is realized by combining, for example, hue/chroma processing, contrast processing, peripheral blurring processing, and synthesis processing. Among them, the peripheral blurring processing is processing that performs low-pass filter processing while changing a low-pass coefficient according to a position in an image so that the greater the distance from the center of the image, the greater the degree of blurring. As the peripheral blurring processing, only upper and lower portions of the image or only left and right portions of the image may be blurred.

Return to FIG. 3. The description of the configuration of the imaging device 1 will be continued.

The AE processing unit 208 acquires the image data recorded in the SDRAM 223 through the bus 226 and sets an exposure condition used when the imaging device 1 captures a still image or a moving image based on the acquired image data. Specifically, the AE processing unit 208 performs automatic exposure of the imaging device 1 by calculating luminance from the image data and determining, for example, a diaphragm value, a shutter speed, and ISO sensitivity on the basis of the calculated luminance.

The AF processing unit 209 acquires the focus data recorded in the SDRAM 223 through the bus 226 and adjusts automatic focusing of the imaging device 1 on the basis of the acquired focus data. For example, the AF processing unit 209 calculates the amount of defocusing of the lens unit 3 by performing distance measurement calculation processing to an object based on the focus data and performs phase difference AF processing (image plane phase difference AF method) that adjusts the automatic focusing of the imaging device 1 according to the calculation result. The AF processing unit 209 may adjust the automatic focusing of the imaging device 1 by determining focus evaluation of the imaging device 1 by extracting a high frequency component signal from the image data and performing Auto Focus (AF) calculation processing (contrast AF method) on the high frequency component signal. Further, the AF processing unit 209 may adjust the automatic focusing of the imaging device 1 by using a pupil division phase difference method.

The image compression/expansion unit 210 acquires the image data and the processed image data from the SDRAM 223 through the bus 226, compresses the acquired image data according to a predetermined format, and outputs the compressed image data to the recording medium 221 through the memory I/F 222. Here, the predetermined format is the Joint Photographic Experts Group (JPEG) method, the Motion JPEG method, the MP4 (H.264) method, or the like. The image compression/expansion unit 210 acquires the image data (compressed image data) recorded in the recording medium 221 through the bus 226 and the memory I/F 222, expands (decompresses) the acquired image data, and outputs the expanded image data to the SDRAM 223.

The input unit 211 includes a power switch 211a that switches a power state of the imaging device 1 to an on state or an off state, a release switch 211b that receives an input of a still image release signal that gives an instruction to capture a still image, an operation switch 211c that switches various settings of the imaging device 1, a menu switch 211d that causes the rear display unit 216 to display the various settings of the imaging device 1, a moving image switch 211e that receives an input of a moving image release signal that gives an instruction to capture a moving image, and a playback switch 211f that causes the rear display unit 216 to display an image corresponding to the image data recorded in the recording medium 221. The release switch 211b can be moved up and down by pressure from the outside. When the release switch 211b is depressed half way, a first release signal, which is an instruction signal that instructs a capturing preparation operation, is received. On the other hand, when the release switch 211b is fully depressed, a second release signal, which is an instruction signal that instructs to capture a still image, is received.

The accessory communication unit 212 is a communication interface for communicating with an external device attached to the main body unit 2.

The eyepiece display unit 213 displays a live view image or a playback image corresponding to the image data recorded in the SDRAM 223 through the bus 226 under control of the main body controller 227. In this sense, the eyepiece display unit 213 functions as an electronic view finder (EVF). The eyepiece display unit 213 is configured by using a display panel including liquid crystal or organic Electro Luminescence (EL), a driving driver, and the like.

The eye sensor 214 detects an approach of a user (object) to the eyepiece display unit 213 and outputs the detection result to the main body controller 227. Specifically, the eye sensor 214 detects whether or not the user checks an image by using the eyepiece display unit 213. The eye sensor 214 is configured by using a contact sensor, an infrared sensor, or the like.

The movable unit 215 is provided with the rear display unit 216 and the touch panel 217 and movably provided to the main body unit 2 through the hinge 215a. For example, the movable unit 215 is provided to the main body unit 2 so that the rear display unit 216 can be changed to face up or face down with respect to the vertical direction of the main body unit 2 (see FIG. 2).

The rear display unit 216 acquires the image data recorded in the SDRAM 223 or the image data recorded in the recording medium 221 through the bus 226 and displays an image corresponding to the acquired image data under control of the main body controller 227. Here, the display of the image includes a rec view display that displays image data immediately after the image data is captured only for a predetermined time (for example, three seconds), a playback display that plays back the image data recorded in the recording medium 221, and a live view display that sequentially displays live view images corresponding to image data continuously generated by the imaging element 203 along time series. The rear display unit 216 is configured by using a display panel including liquid crystal or organic EL, a driving driver, and the like. The rear display unit 216 appropriately displays operation information of the imaging device 1 and information related to capturing. In the first embodiment, the eyepiece display unit 213 and the rear display unit 216 function as a display unit.

The touch panel 217 is provided to be superimposed on a display screen of the rear display unit 216. The touch panel 217 detects touch of an object from the outside and outputs a position signal corresponding to the detected touch position to the main body controller 227. The touch panel 217 may detect a position touched by a user based on information displayed on the rear display unit 216, for example, an icon image and a thumbnail image, and receive an instruction signal that instructs an operation performed by the imaging device 1 and a selection signal that selects an image according to the detected touch position. In general, as the touch panel 217, there are a resistance film type, an electrostatic capacitance type, and an optical type. In the first embodiment, any type of touch panel can be applied. Further, the movable unit 215, the rear display unit 216, and the touch panel 217 may be integrally formed.

The rotation determination unit 218 determines a rotation state of the movable unit 215 and outputs the detection result to the main body controller 227. For example, the rotation determination unit 218 determines whether or not the movable unit 215 is moving with respect to the main body unit 2 and outputs the determination result to the main body controller 227.

The state detector 219 is configured by using an acceleration sensor and a gyro sensor. The state detector 219 detects acceleration and angular velocity generated by the imaging device 1 and outputs the detection result to the main body controller 227.

The clock 220 has a clocking function and a determination function of date and time of capturing. The clock 220 outputs date and time data to the main body controller 227 to add the date and time data to the image data imaged by the imaging element 203.

The recording medium 221 is configured by using a memory card or the like attached from the outside of the imaging device 1. The recording medium 221 is attachably and detachably attached to the imaging device 1 through the memory I/F 222. The image data processed by the image processing unit 207 and the image compression/expansion unit 210 is written to the recording medium 221. The recorded image data is read from the recording medium 221 by the main body controller 227.

The SDRAM 223 temporarily records image data inputted from the A/D converter 206 through the bus 226, image data inputted from the image processing unit 207, and information being processed by the imaging device 1. For example, the SDRAM 223 temporarily records image data sequentially outputted from the imaging element 203 for each frame through the signal processing unit 205, the A/D converter 206, and the bus 226. The SDRAM 223 is configured by using a volatile memory.

The flash memory 224 includes a program recording unit 224a. The program recording unit 224a records various programs to operate the imaging device 1, a programs according to the first embodiment, various data used while the programs are being executed, parameters of each image processing necessary for image processing operations performed by the image processing unit 207, combinations of image processing of the special effect processing performed by the special effect processing unit 207f illustrated in FIG. 4, and the like. The flash memory 224 is configured by using a non-volatile memory.

The main body communication unit 225 is a communication interface for communicating with the lens unit 3 attached to the main body unit 2.

The bus 226 is configured by using a transmission path or the like that connects each component of the imaging device 1 together. The bus 226 transmits various data generated in the imaging device 1 to each component of the imaging device 1.

The main body controller 227 is configured by using a Central Processing Unit (CPU) and the like. The main body controller 227 integrally controls the operation of the imaging device 1 by transmitting a corresponding instruction and data to each component included in the imaging device 1 according to an instruction signal from the input unit 211 and a position signal from the touch panel 217.

A detailed configuration of the main body controller 227 will be described. The main body controller 227 includes an imaging controller 227a and a display controller 227b.

When the release signal is inputted from the release switch 211b to the imaging controller 227a, the imaging controller 227a performs control to start a capturing operation in the imaging device 1. Here, the capturing operation in the imaging device 1 is an operation in which the signal processing unit 205, the A/D converter 206, and the image processing unit 207 perform predetermined processing on the image data outputted from the imaging element 203 by drive of the shutter drive unit 202. The image data processed in this way is compressed by the image compression/expansion unit 210 under control of the imaging controller 227a and recorded in the recording medium 221 through the bus 226 and the memory I/F 222.

The display controller 227b causes the rear display unit 216 and/or the eyepiece display unit 213 to display an image corresponding to the image data. Specifically, when the power of the eyepiece display unit 213 is on state, the display controller 227b causes the eyepiece display unit 213 to display a live view image corresponding to the image data. On the other hand, when the power of the eyepiece display unit 213 is off state, the display controller 227b causes the rear display unit 216 to display the live view image corresponding to the image data.

The main body unit 2 having the above configuration may further include a voice input/output function, a flash function, and a communication function or the like that can bidirectionally communicate with external devices.

Next, the lens unit 3 will be described. The lens unit 3 includes a zoom lens 301, a zoom drive unit 302, a zoom position detector 303, a diaphragm 304, a diaphragm drive unit 305, a diaphragm value detector 306, a focus lens 307, a focus drive unit 308, a focus position detector 309, a lens operating unit 310, a lens flash memory 311, a lens communication unit 312, and a lens controller 313.

The zoom lens 301 is configured by using one or a plurality of lenses. The zoom lens 301 changes the magnification of optical zoom of the imaging device 1 by moving along the optical axis O of the lens unit 3. For example, the zoom lens 301 can change the focal length in a range of 12 mm to 50 mm.

The zoom drive unit 302 is configured by using a DC motor, a stepping motor, or the like. The zoom drive unit 302 changes the optical zoom of the imaging device 1 by moving the zoom lens 301 along the optical axis O under control of the lens controller 313.

The zoom position detector 303 is configured by using a photo-interrupter or the like. The zoom position detector 303 detects the position of the zoom lens 301 on the optical axis O and outputs the detection result to the lens controller 313.

The diaphragm 304 adjusts exposure by limiting the amount of incident light collected by the zoom lens 301.

The diaphragm drive unit 305 is configured by using a stepping motor or the like. The diaphragm drive unit 305 changes the diaphragm value (F-number) of the imaging device 1 by driving the diaphragm 304 under control of the lens controller 313.

The diaphragm value detector 306 is configured by using a photo-interrupter, an encoder, and the like. The diaphragm value detector 306 detects the diaphragm value from the current state of the diaphragm 304 and outputs the detection result to the lens controller 313.

The focus lens 307 is configured by using one or a plurality of lenses. The focus lens 307 changes the focus position of the imaging device 1 by moving along the optical axis O of the lens unit 3. In the first embodiment, the zoom lens 301 and the focus lens 307 function as an optical system.

The focus drive unit 308 is configured by using a DC motor, a stepping motor, or the like. The focus drive unit 308 adjusts the focus position of the imaging device 1 by moving the focus lens 307 along the optical axis O under control of the lens controller 313.

The focus position detector 309 is configured by using a photo-interrupter or the like. The focus position detector 309 detects the position of the focus lens 307 on the optical axis O and outputs the detection result to the lens controller 313.

The lens operating unit 310 is a ring provided around the lens barrel of the lens unit 3 as illustrated in FIG. 1. The lens operating unit 310 receives an input of an instruction signal that instructs a change of the optical zoom of the lens unit 3 or an input of an instruction signal that instructs adjustment of the focus position of the lens unit 3. The lens operating unit 310 may be a push type switch, a lever type switch, or the like.

The lens flash memory 311 records a control program for determining positions and movements of the zoom lens 301, the diaphragm 304, and the focus lens 307, and lens characteristics and various parameters of the lens unit 3. Here, the lens characteristics are chromatic aberration, view angle information, brightness information (f-number), and focal length information (for example, 50 mm to 300 mm) of the lens unit 3.

The lens communication unit 312 is a communication interface for communicating with the main body communication unit 225 of the main body unit 2 when the lens unit 3 is attached to the main body unit 2.

The lens controller 313 is configured by using a CPU and the like. The lens controller 313 controls the movement of the lens unit 3 according to an instruction signal from the lens operating unit 310 or an instruction signal from the main body unit 2. Specifically, the lens controller 313 adjusts the focus position of the focus lens 307 by driving the focus drive unit 308 and changes the zoom magnification of optical zoom of the zoom lens 301 by driving the zoom drive unit 302 according to the instruction signal from the lens operating unit 310. The lens controller 313 may transmit the lens characteristics of the lens unit 3 and identification information for identifying the lens unit 3 to the main body unit 2 when the lens unit 3 is attached to the main body unit 2.

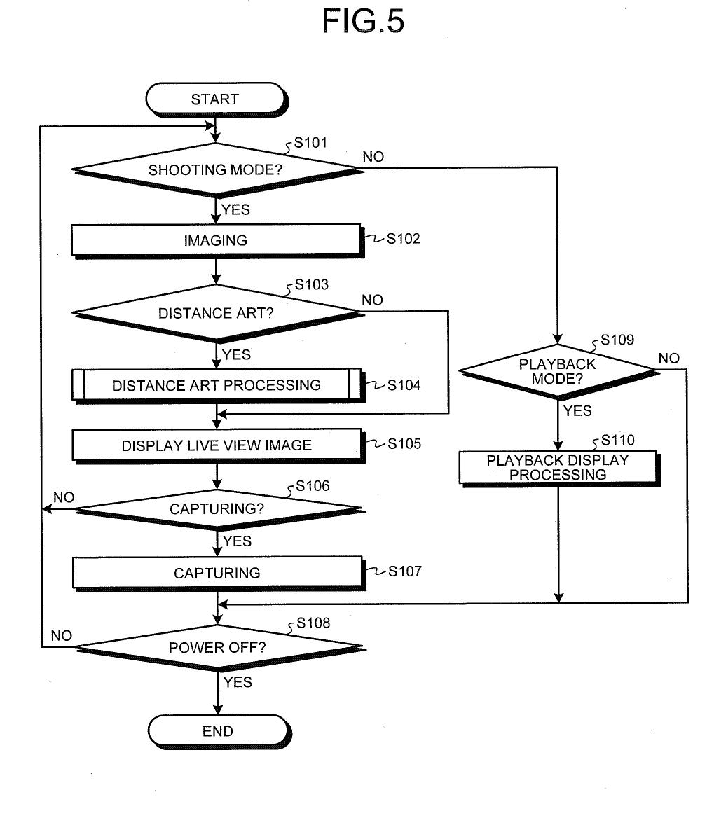

The processing executed by the imaging device 1 having the configuration described above will be described. FIG. 5 is a flowchart illustrating an overview of the processing executed by the imaging device 1.

As illustrated in FIG. 5, first, a case in which the imaging device 1 is set to an shooting mode when the imaging device 1 whose power switch 211a is operated is started (step S101: Yes) will be described. In this case, the imaging controller 227a causes the imaging element 203 to perform imaging by causing the imaging element drive unit 204 to drive (step S102).

Subsequently, when a distance art is set in the imaging device 1 (step S103: Yes), the imaging device 1 executes distance art processing which generates processed image data by causing the image data to execute the special effect processing by changing parameters of the special effect processing performed by the special effect processing unit 207f according to distances to objects existing along a direction moving away from the imaging device 1 (step S104). A detailed description of the distance art processing will be described later. On the other hand, when the distance art is not set in the imaging device 1 (step S103: No), the imaging device 1 proceeds to step S105.

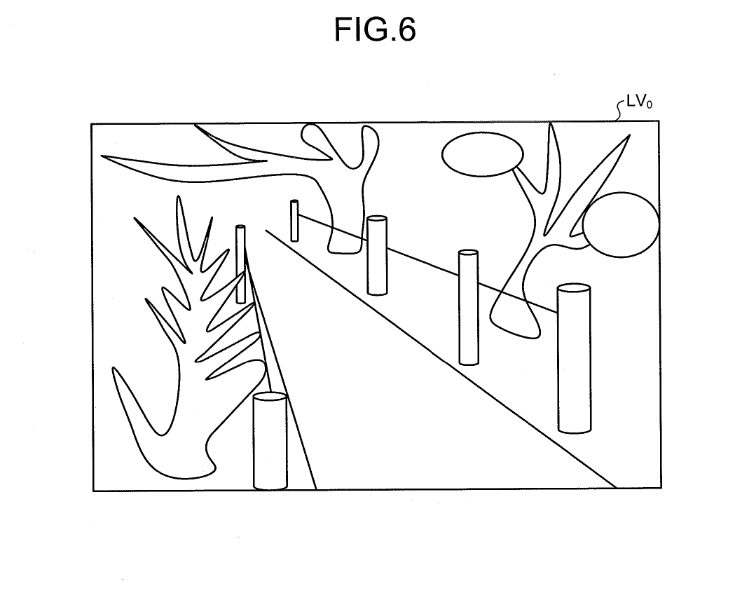

Subsequently, the display controller 227b causes the eyepiece display unit 213 or the rear display unit 216 to display the live view image corresponding to the live view image data which is imaged by the imaging element 203 and on which the signal processing unit 205, the A/D converter 206, and the image processing unit 207 respectively perform predetermined processing (step S105). In this case, when the eye sensor 214 detects a person who captures an image (object), the display controller 227b causes the eyepiece display unit 213 to display the live view image. For example, the display controller 227b causes the eyepiece display unit 213 to display a live view image LV0 illustrated in FIG. 6. FIG. 6 illustrates a state in which basic image processing of the basic image processing unit 207a is performed on the image data.

Thereafter, when a release signal that instructs to perform capturing is inputted from the release switch 211b (step S106: Yes), the imaging controller 227a executes capturing (step S107). In this case, when the distance art is set in the imaging device 1, the imaging controller 227a records processed image data generated by causing the special effect processing unit 207f to execute the special effect processing according to setting contents set by the distance art processing described later in the recording medium 221.

Subsequently, when the power switch 211a is operated and the power of the imaging device 1 is turned off (step S108: Yes), the imaging device 1 terminates the present processing. On the other hand, when the power switch 211a is not operated and the power of the imaging device 1 is not turned off (step S108: No), the imaging device 1 returns to step S101.

In step S106, when the release signal that instructs to perform capturing is not inputted from the release switch 211b (step S106: No), the imaging device 1 returns to step S101.

A case will be described in which the imaging device 1 is not set to the shooting mode in step S101 (step S101: No). In this case, when the imaging device 1 is set to a playback mode (step S109: Yes), the imaging device 1 performs playback display processing that causes the rear display unit 216 or the eyepiece display unit 213 to display an image corresponding to the image data recorded in the recording medium 221 (step S110). After step S110, the imaging device 1 proceeds to step S108.

When the imaging device 1 is not set to the playback mode in step S109 (step S109: No), the imaging device 1 proceeds to step S108.

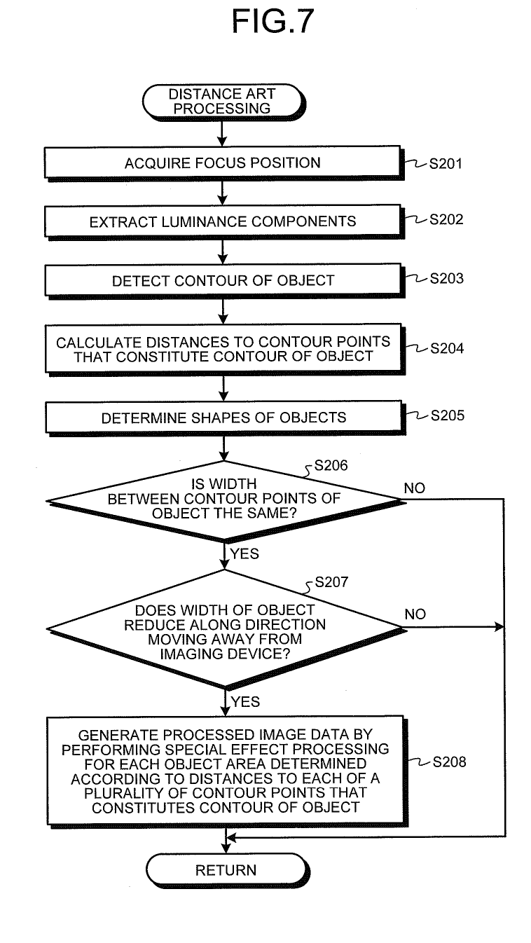

Next, the distance art processing described in step S104 in FIG. 5 will be described in detail. FIG. 7 is a flowchart illustrating an overview of the distance art processing.

As illustrated in FIG. 7, the focus position acquisition unit 207d acquires the current focus position from the lens unit 3 (step S201).

Subsequently, the contour detector 207b acquires image data from the SDRAM 223, extracts luminance components included in the acquired image data (step S202), and detects a contour of an object by calculating second derivative absolute values of the extracted luminance components (step S203).

Subsequently, the distance calculation unit 207c calculates distances from the imaging device 1 to the contour points that constitute the contour of the object detected by the contour detector 207b on the basis of the focus data generated by the AF pixels 203a stored in the SDRAM 223 (step S204). Specifically, the distance calculation unit 207c performs distance measurement calculation processing which calculates values related to each distance from the imaging element 203 to a plurality of contour points that constitutes the contour of the object detected by the contour detector 207b on the basis of the focus data generated by the AF pixels 203a. The distance calculation unit 207c may calculate values related to each distance to the plurality of contour points that constitutes the contour of the object every time the focus lens 307 moves on the optical axis O. Further, the distance calculation unit 207c may calculate the values related to distances to the contour points that constitute the contour of the object every time the focus lens 307 is driven by Wob-drive in which the focus lens 307 reciprocates over a small distance from the focus position. The distance calculation unit 207c may calculate values related to distances to at least two of the plurality of contour points that constitutes the contour of the object.

Thereafter, the shape determination unit 207e determines the shapes of physical objects (objects) which have the same color (low-contrast) and whose distances are different from each other in the contour of the object on the basis of the contour of the object detected by the contour detector 207b and the distances to the plurality of contour points that constitutes the contour of the object calculated by the distance calculation unit 207c (step S205). Specifically, the shape determination unit 207e determines whether or not the shapes of the objects are the same along the optical axis O of the lens unit 3.

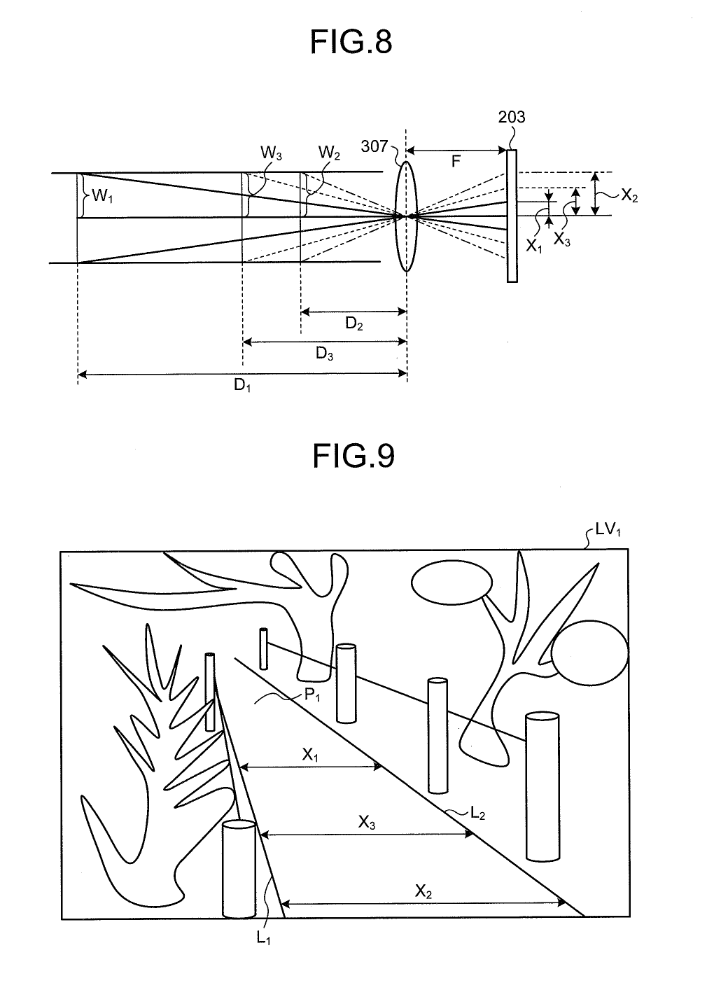

FIG. 8 is a schematic diagram illustrating an overview of a determination method for determining shapes of objects whose distances are different from each other, by the shape determination unit 207e. FIG. 9 illustrates an example of an image determined by the shape determination unit 207e. The width between a contour L1 and a contour L2 of an object P1 (a road existing along a direction moving away along the optical axis O of the lens unit 3) on an image LV1 in FIG. 9 corresponds to the width on an imaging plane on which an image is formed on the imaging element 203.

As illustrated in FIGS. 8 and 9, first, the shape determination unit 207e determines the widths of physical objects as the shapes of physical objects which have the same color and whose distances are different from each other in the contour of the object on the basis of the contour of the object detected by the contour detector 207b and the distances to the contour points of the object calculated by the distance calculation unit 207c. Specifically, when the widths of different images formed on the imaging element 203 are X1 and X2 and the focal length of the lens unit 3 is F, the shape determination unit 207e determines the widths W1 and W2 of the objects whose distances from the imaging device 1 are D1 and D2 respectively by the following formulas (1) to (4).

W1:D1=X1:F (1)

Therefore, the following formula is established.

W1=(D1X1)/F (2)

In the same manner,

W2:D2=X2:F (3)

Therefore, the following formula is established.

W2=(D2X2)/F (4)

In this case, when W1≈W2, the following formula (5) is established from the formulas (2) and (4).

D1X1≈D2X2 (5)

In other words, the shape determination unit 207e determines whether or not the width of the contour (the width between the contour points) of the object P1 is the same along the depth direction moving away from the imaging device 1 by using the formulas (2), (4), and (5). Further, when the width of an image formed on the imaging element 203 is X3 and the focal length is F, the shape determination unit 207e determines the width W3 of a physical object whose distance from the imaging element 203 is D3 by the following formulas (6) and (7).

W3:D3=X3:F (6)

Therefore, the following formula is established.

W3=(D3X3)/F (7)

In this case, when W1≈W3, the following formula (8) is established from the formulas (2) and (7).

D1X1≈D3X3 (8)

Therefore, the following formula is established.

X3=D1X1/D3 (9)

In this way, the shape determination unit 207e determines whether or not the width between the contours L1 and L2 of the object P1 at the focus position of the lens unit 3 is the same by using the formula (8).

Subsequently, when the shape determination unit 207e determines that the width between the contour points of the object detected by the contour detector 207b is the same (step S206: Yes), the imaging device 1 proceeds to step S207 described later. On the other hand, when the shape determination unit 207e determines that the width between the contours of the object detected by the contour detector 207b is not the same (step S206: No), the imaging device 1 returns to a main routine in FIG. 5. In this case, the display controller 227b may make a warning by information such as a picture, an icon, and characters, which indicates that the distance art cannot be performed on the live view image displayed by the rear display unit 216.

In step S207, the shape determination unit 207e determines whether or not the width between the contours of the object detected by the contour detector 207b reduces on the image along a direction moving away from the imaging device 1. Specifically, the shape determination unit 207e determines whether or not the width between the contours of the object detected by the contour detector 207b reduces in a light receiving area on the imaging element 203. For example, in the case of FIG. 9, the width of the object P1 reduces on the image LV1 from the lower end toward the upper end along the depth direction moving away from the imaging device 1, so that the shape determination unit 207e determines that the width between the contours of the object detected by the contour detector 207b reduces on the image in the direction moving away from the imaging device 1. When the shape determination unit 207e determines that the width between the contours of the object detected by the contour detector 207b reduces on the image along the direction moving away from the imaging device 1 (step S207: Yes), the imaging device 1 proceeds to step S208 described later. On the other hand, when the shape determination unit 207e determines that the width between the contours of the object detected by the contour detector 207b does not reduce on the image along the direction moving away from the imaging device 1 (step S207: No), the imaging device 1 returns to the main routine in FIG. 5. This side (near side) of the road and the other side (far side) of the road are determined by using not only the contours obtained from the image, but also the edges of the screen. Therefore, although the special effect processing unit 207f detects a contour of an object in an image corresponding to the image data generated by the imaging element 203 and generates processed image data that produces a visual effect by performing different image processing for each object area surrounded by the contour of the object according to a perspective distribution of a plurality of contour points that constitutes the contour of the object, the special effect processing unit 207f determines the object area by effectively using the edges of the screen as needed and performs the special effect processing.

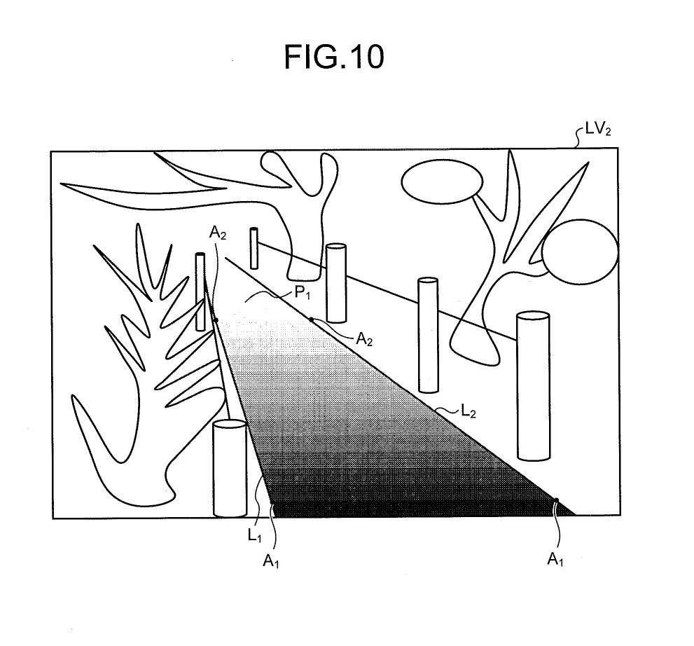

In step S208, the special effect processing unit 207f generates processed image data by performing the special effect processing for each object area determined according to distances to each of a plurality of contour points that constitutes the contour of the object, which are calculated by the distance calculation unit 207c, on the image data generated by the basic image processing unit 207a. Thereby, as illustrated in FIG. 10, the image LV2 corresponding to the processed image data generated by the special effect processing unit 207f is an image in which parameters of image processing are gradually changed for each distance along a direction (depth direction) moving away from the imaging device 1 in the visual field of the imaging device 1. The special effect processing performed by the special effect processing unit 207f is select and set by the input unit 211 or the touch panel 217 in advance.

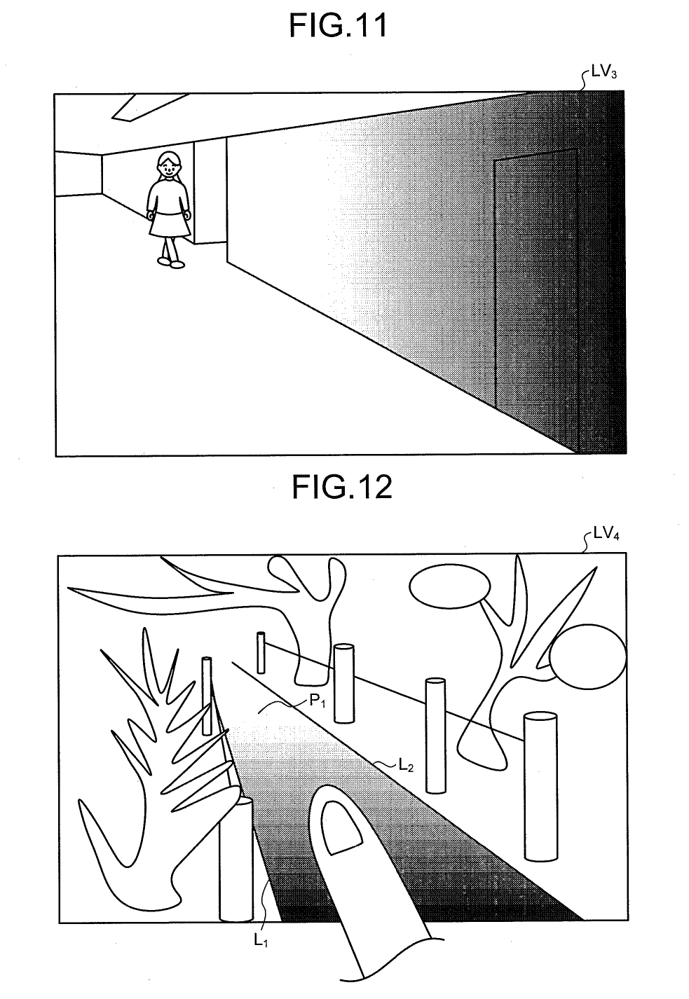

In FIG. 10, regarding the parameters of the image processing, hatching for gradation is represented in order to schematically illustrate the special effect processing (for example, pop art in FIG. 4) in which parameters of chroma and contrast are changed for each position or each area corresponding to each distance from the imaging device 1 to a plurality of contour points (for example, contour points A1 and A2) that constitutes the contour of the object P1. Of course, as the parameters of the image processing, parameters of chroma, hue, gradation, contrast, white balance, sensitivity, intensity of soft focus, intensity of shading, and the like may be superimposed or changed. The special effect processing unit 207f can perform the special effect processing not only in the horizontal direction of the image but also in the vertical direction of the image as illustrated by the image LV3 illustrated in FIG. 11. In summary, in these embodiments, straight lines converging into a specific position in a screen in perspective are determined to be substantially parallel lines extending in the depth direction, such as both sides of a road, a wall or a corridor of a building and when the same distance points on the parallel lines are connected, an area defined according to the same distances can be virtually determined and image-processed even if there is no contrast and no distance information. The embodiment uses this effect. After step S208, the imaging device 1 returns to the main routine in FIG. 5. In this way, distance distribution of a monotonic portion of relatively low contrast is estimated from transition of distance information of a contour and variation is given to the monotonic portion according to the distance distribution, so that it is possible to effectively obtain a good-looking image. An area sandwiched by contours with such distance variation is a candidate of an image processing area of the present invention.

According to the first embodiment of the present invention described above, it is possible to perform image processing different for each distance from the imaging device 1 on an object existing along a direction moving away from the imaging device 1.

Further, according to the first embodiment of the present invention, the distance calculation unit 207c calculates each distance to a plurality of contour points that constitutes the contour of the object detected by the contour detector 207b and the special effect processing unit 207f generates a visual effect by performing different image processing for each object area determined by each distance to the plurality of contour points that constitutes the contour of the object detected by the distance calculation unit 207c. Thereby, even when an object is captured in a scene with no contrast, it is possible to generate processed image data on which different image processing is performed for each distance from the imaging device 1. Therefore, it is possible to perform expressive image processing and image representation which give a sense of depth to the screen and effectively use distance information (need not necessarily be absolute distances, but may be relative perspective information and concave/convex information), and further, it is possible to transmit information to a user by using the image. It goes without saying that art representation using a sense of perspective, which is an important factor of image representation, gives a sense of presence and attracts those who see the representation with more natural effects.

In the first embodiment of the present invention, the distance calculation unit 207c calculates the values related to each distance to a plurality of contour points that constitutes the contour of the object detected by the contour detector 207b. However, the distance calculation unit 207c may calculate the values related to the distances to the object selected through the touch panel 217. FIG. 12 is a schematic diagram illustrating a situation of selecting an object through the touch panel 217. As illustrated in FIG. 12, the distance calculation unit 207c may calculate the values related to the distances to the object P1 on the image LV4 touched through the touch panel 217 in a direction moving away from the imaging device 1.

Although, in the first embodiment of the present invention, the parameters of image processing are changed as the image processing of the special effect processing unit 207f, for example, a combination of the image processing may be changed for each position corresponding to each distance from the imaging device 1 to a plurality of contour points that constitutes the object. Further, the special effect processing unit 207f may synthesize image data formed by extracting a predetermined wavelength band (for example, red: 600 nm-700 nm, green: 500 nm-600 nm, and blue: 400 nm-500 nm) for each position corresponding to each distance from the imaging device 1 to a plurality of contour points that constitutes the object.

In the first embodiment of the present invention, the present invention can be applied by mounting the image processing unit 207 as an image processing device in another device, for example, a mobile phone and a portable terminal device. Further, the present invention can be applied by mounting the image processing unit 207 in a processing device of an endoscope system including an endoscope device that images inside a subject and generates image data of the subject, the processing device that performs image processing on the image data from the endoscope device, and a display device that displays an image corresponding to the image data on which the image processing is performed by the processing device. It goes without saying that when it is possible to cause an observer or an operator to intuitively grasp an image emphasized by image processing, it is effective for industrial observation devices and medical testing devices. It is possible to support observer's visual perception and help observer's understanding by an image representation according to depth information (information of distances from the imaging device 1).

### Second Embodiment

Next, a second embodiment of the present invention will be described. The imaging device according to the second embodiment includes an image processing unit whose configuration is different from that of the image processing unit of the imaging device 1 according to the first embodiment described above and executes distance art processing different from that executed by the imaging device. Therefore, in the description below, a configuration of the imaging device according to the second embodiment will be described, and then the distance art processing executed by the imaging device will be described. The same components as those in the imaging device 1 according to the first embodiment described above are given the same reference numerals and the description thereof will be omitted.

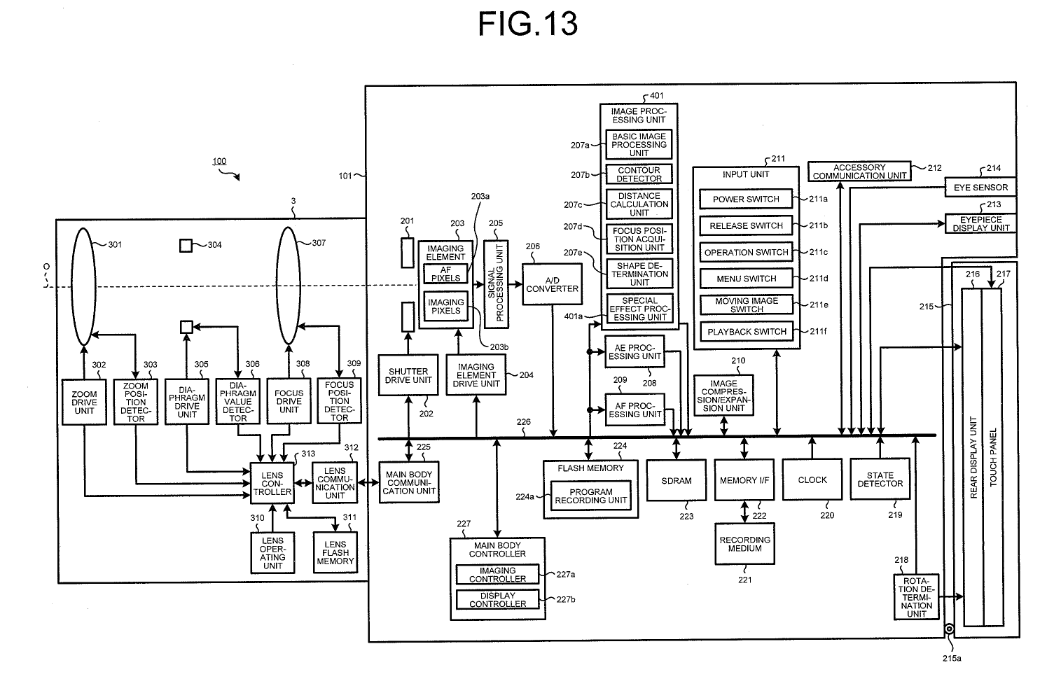

FIG. 13 is a block diagram illustrating a functional configuration of the imaging device according to the second embodiment. An imaging device 100 illustrated in FIG. 13 includes a lens unit 3 and a main body unit 101. The main body unit 101 includes an image processing unit 401 instead of the image processing unit 207 of the first embodiment described above.

The image processing unit 401 includes a basic image processing unit 207a, a contour detector 207b, a distance calculation unit 207c, a focus position acquisition unit 207d, a shape determination unit 207e, and a special effect processing unit 401a.

The special effect processing unit 401a generates processed image data by performing special effect processing which superimposes one or more of text data, graphic data, and symbolic data on an image corresponding to the image data on the basis of each distance from the imaging device 100 to a plurality of contour points that constitutes a contour of an object detected by the contour detector 207b, which is calculated by the distance calculation unit 207c.

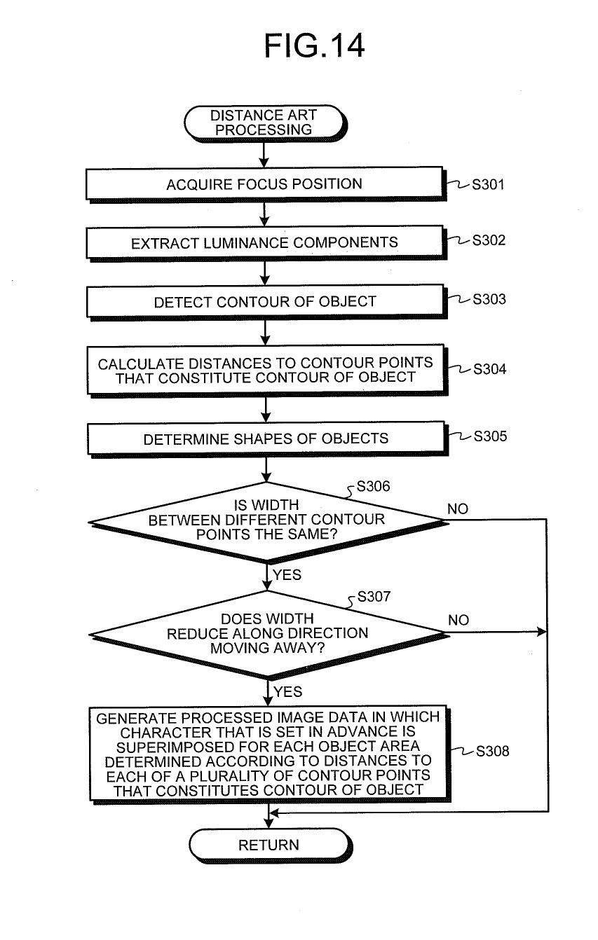

Next, the distance art processing executed by the imaging device 100 will be described. FIG. 14 is a flowchart illustrating an overview of the distance art processing executed by the imaging device 100. In FIG. 14, steps S301 to S307 correspond to steps S201 to S207 in FIG. 7, respectively.

In step S308, the special effect processing unit 401a generates processed image data in which characters that are set as text data in advance are superimposed on the image data on which basic image processing is performed by the basic image processing unit 207a for each object area determined according to distances from the imaging device 100 to each of a plurality of contour points that constitutes the contour of the object detected by the contour detector 207b, which are calculated by the distance calculation unit 207c. Specifically, the special effect processing unit 401a generates processed image data in which characters that are set in advance are superimposed in a contour between contour points whose distances from the imaging device 100 are different from each other among a plurality of contour points that constitutes the contour of the object detected by the contour detector 207b, is the distances being calculated by the distance calculation unit 207c.

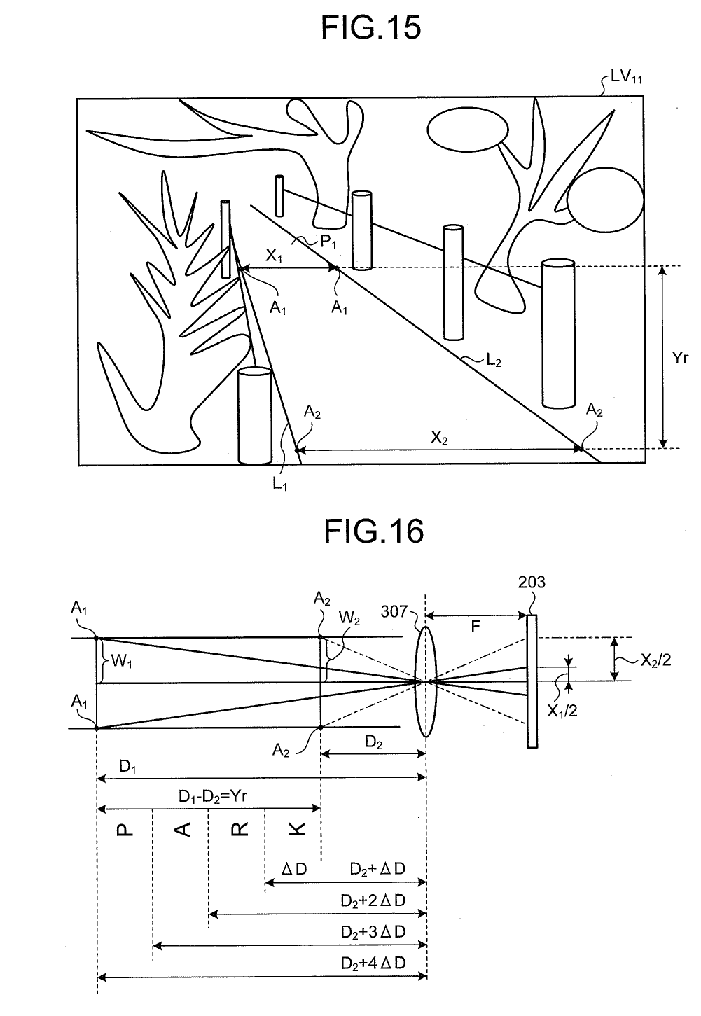

FIG. 15 is a diagram illustrating an example of an image on which the special effect processing unit 401a superimposes characters. FIG. 16 is a schematic diagram illustrating an overview of a method of assigning characters when the special effect processing unit 401a superimposes the characters in a contour of an object. In the image LV11 in FIG. 15, an assigning method will be described which assigns characters on an area of the object P1 sandwiched by contour points A1 and contour points A2 whose distances are different from each other among a plurality of contour points that constitutes the contour of the object P1. In FIGS. 15 and 16, it is assumed that the number of characters that are set in advance is four (PARK).

As illustrated in FIGS. 15 and 16, the special effect processing unit 401a assigns areas of the characters that are set in advance in the contour of the object P1 sandwiched by contour points whose distances calculated by the distance calculation unit 207c are different from each other among a plurality of contour points that constitutes the contour of the object. Specifically, when the distance from the imaging device 100 to the contour point A1 of the object P1 is D1, the distance from the imaging device 100 to the contour point A2 of the object P1 is D2, and the number of characters to be superimposed on the image LV11 is N, the special effect processing unit 401a calculates an area ΔD per character by the following formula (10).

ΔD=(D1−D2)/N (10)

Then, the special effect processing unit 401a sets the size of a character in the area ΔD to be superimposed on the image LV11 on the basis of the area ΔD and the height Yr from the distance D1 to the distance D2 on the image LV11. For example, the special effect processing unit 401a sets the sizes of each character in the area ΔD on the image so that the size of the character reduces along a direction moving away from the imaging device 100 (from the lower end toward the upper end on the image LV11). Specifically, when the sizes of each character in the area ΔD on the image are X11 to X14, the special effect processing unit 401a sets the sizes of each character in the area ΔD so that the following condition (11) is satisfied.

X11:X12:X13:X14=(1/(D2+3·ΔD)−1/D1):(1/(D2+2·ΔD)−1/(D2+3·ΔD)):(1/(D2−ΔD)−1/(D2+2·ΔD)):(1/D2−1/(D1+ΔD)) (11)

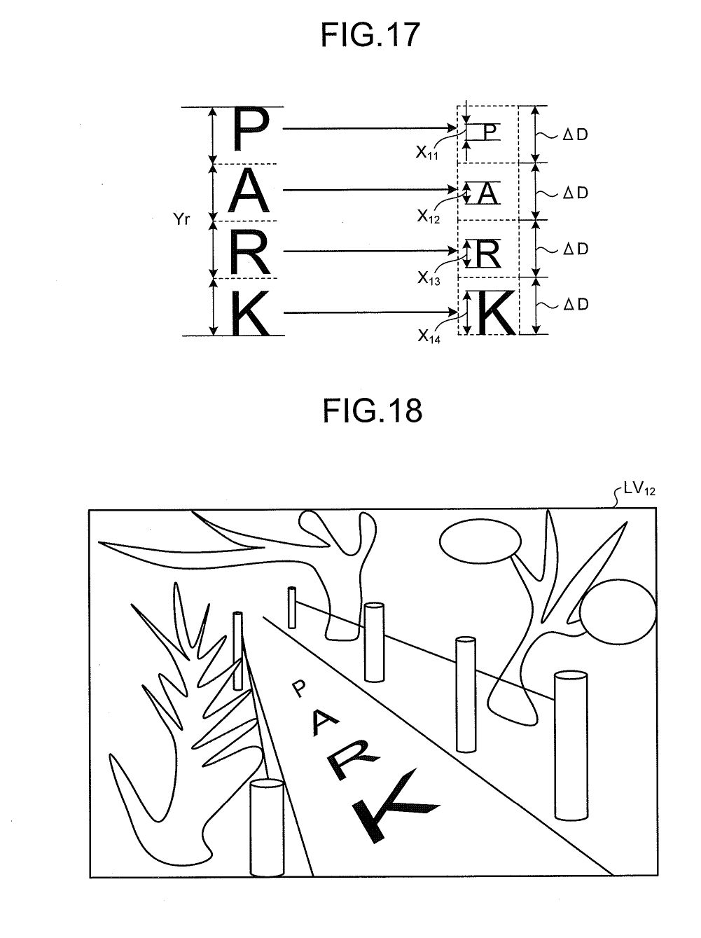

In this way, the special effect processing unit 401a adjusts the sizes of the characters to be superimposed on the image LV11 so that the sizes are in the ratio of the condition (11). Specifically, the special effect processing unit 401a adjusts the sizes of the characters to be superimposed on the image LV11 as illustrated in FIG. 17. Thereafter, the special effect processing unit 401a generates processed image data in which each character is superimposed on the image LV11. Thereby, as illustrated in FIG. 18, the image LV12 corresponding to the processed image data generated by the special effect processing unit 401a is an image in which the size of each character gradually reduces along a direction moving away from the imaging device 100, so that the image shows natural finish according to the reduction of the width of the object P1. The special effect processing unit 401a may adjust the sizes of the characters to be superimposed on the image LV11 so that the sizes are a reciprocal of a distance from the imaging device 100. After step S308, the imaging device 100 returns to the main routine in FIG. 5.

According to the second embodiment of the present invention described above, it is possible to perform image processing in which a different character is superimposed for each distance from the imaging device 100 on an object existing along a direction moving away from the imaging device 100. Therefore, it is possible to perform expressive image processing and image representation which give a sense of depth to the screen and effectively use distance information (need not necessarily be absolute distances, but may be relative perspective information and concave/convex information), and further, it is possible to transmit information to a user by using the image. By the image representation according to the depth information, it is possible to support observer's visual perception and prevent mistake in vision. The image representation is effective to display auxiliary information that prevents errors in the next capturing and the next behavior, so that the image representation can support capturing and observation.

Further, according to the second embodiment of the present invention, the distance calculation unit 207c calculates the values related to each distance to a plurality of contour points that constitutes the contour of the object detected by the contour detector 207b and the special effect processing unit 401a generates a visual effect by performing different image processing for each position corresponding to each distance to the plurality of contour points that constitutes the contour of the object, which is detected by the distance calculation unit 207c. Thereby, even when an object is captured in a scene with no contrast, it is possible to generate processed image data on which a different character is superimposed for each distance from the imaging device 100. In other words, distance distribution of a monotonic portion of relatively low contrast is estimated from transition of distance information of a contour and variation is given to the monotonic portion according to the distance distribution, so that it is possible to effectively obtain a good-looking image.

In the second embodiment of the present invention, the special effect processing unit 401a superimposes characters as text data. However, the special effect processing unit 401a may superimpose graphics and symbols that are set in advance as graphics data to generate the processed image data.

### Third Embodiment

Next, a third embodiment of the present invention will be described. The imaging device according to the third embodiment includes an image processing unit whose configuration is different from that of the image processing unit of the imaging device 1 according to the first embodiment described above and executes distance art processing different from that executed by the imaging device. Therefore, in the description below, a configuration of the imaging device according to the third embodiment will be described, and then the distance art processing executed by the imaging device will be described. The same components as those in the imaging device 1 according to the first embodiment described above are given the same reference numerals and the description thereof will be omitted.

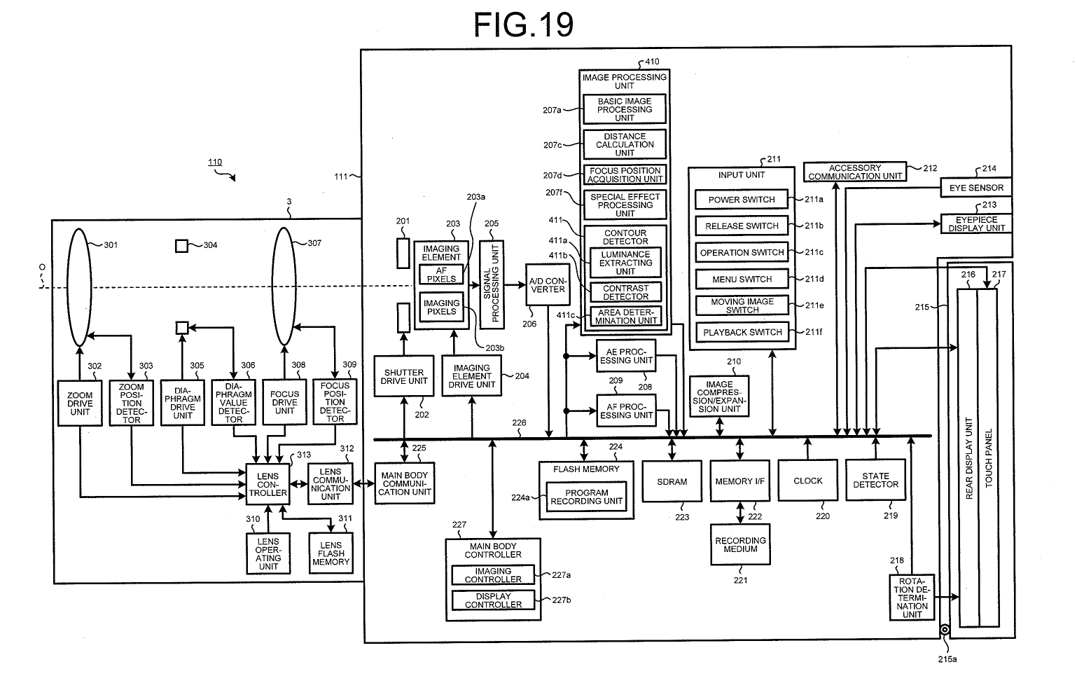

FIG. 19 is a block diagram illustrating a functional configuration of the imaging device according to the third embodiment. An imaging device 110 illustrated in FIG. 19 includes a lens unit 3 and a main body unit 111. The main body unit 111 includes an image processing unit 410 instead of the image processing unit 207 of the first embodiment described above.

The image processing unit 410 includes a basic image processing unit 207a, a distance calculation unit 207c, a focus position acquisition unit 207d, and a special effect processing unit 207f, and a contour detector 411.

The contour detector 411 detects a contour of an object in an image corresponding to the image data generated by the imaging element 203. The contour detector 411 includes a luminance extracting unit 411a that extracts luminance components of the image data generated by the imaging element 203, a contrast detector 411b that detects contrast of the image data based on the luminance components extracted by the luminance extracting unit 411a, and an area determination unit 411c that determines an area sandwiched by peaks (tops) of contrast different from each other, which are detected by the contrast detector 411b, in an image corresponding to the image data. The area determination unit 411c determines whether or not a position touched on the touch panel 217 is an area sandwiched by peaks of contrast different from each other. Such an area is a monotonic area and a portion that can be easily changed by image processing. The image processing can be performed more easily on the area than on an area of high contrast. When the width of the area gradually reduces in perspective, there is a high probability that the area is an area whose distance changes.

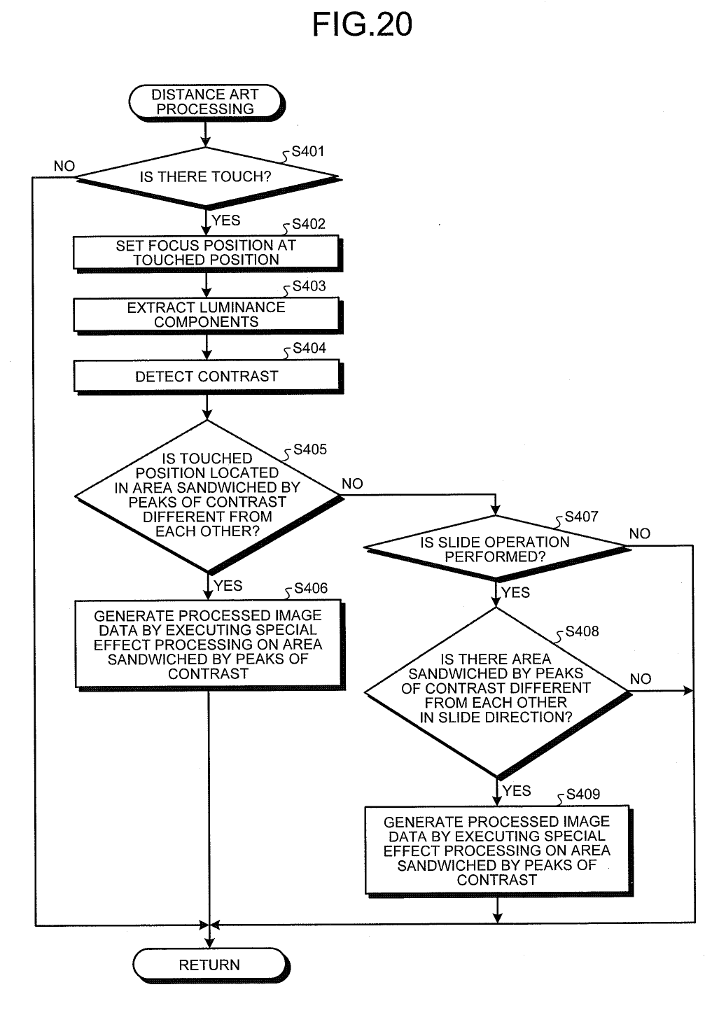

Next, the distance art processing executed by the imaging device 110 will be described. FIG. 20 is a flowchart illustrating an overview of the distance art processing executed by the imaging device 110.

As illustrated in FIG. 20, first, when there is a touch to the touch panel 217 (step S401: Yes), the imaging controller 227a sets a focus position of the lens unit 3 to a visual field area corresponding to an image at the touched position (step S402). Specifically, the imaging controller 227a moves the focus lens 307 on the optical axis O so that the focus position of the lens unit 3 is set to the touched position by controlling the lens unit 3.

Subsequently, the luminance extracting unit 411a acquires image data from the SDRAM 223 and extracts luminance components included in the acquired image data (step S403), and the contrast detector 411b detects contrast of the image data based on the luminance components detected by the luminance extracting unit 411a (step S404).

Thereafter, the area determination unit 411c determines whether or not the touched position is located in an area sandwiched by peaks of contrast different from each other (step S405).

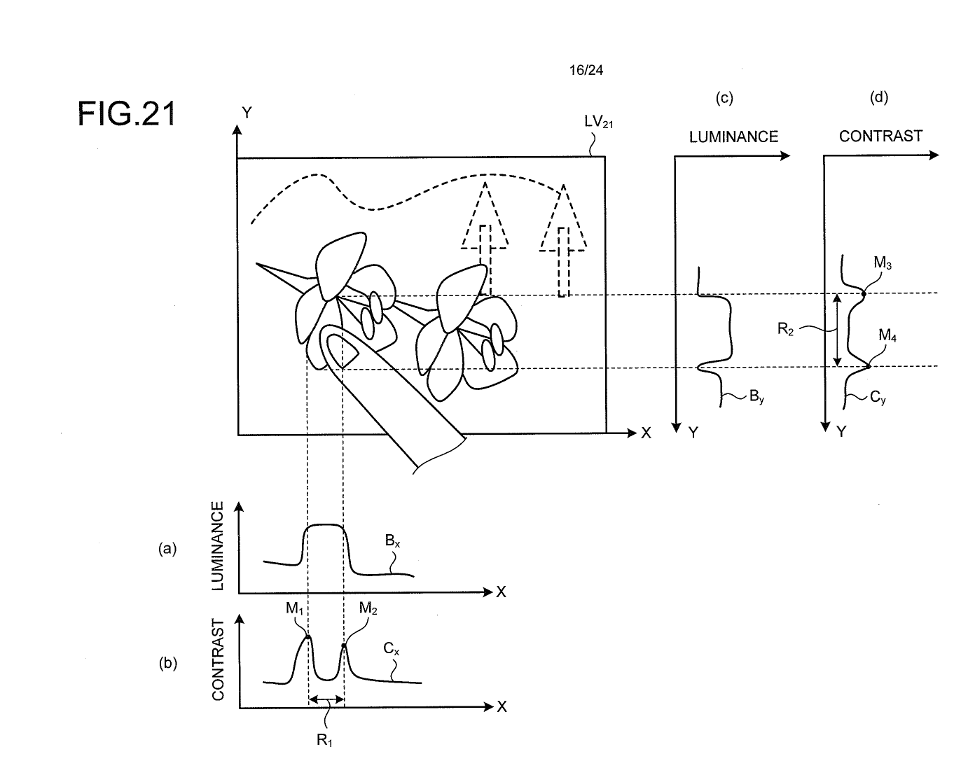

FIG. 21 is a series of schematic diagrams illustrating an overview of a determination method for determining an area sandwiched by peaks of contrast, by the area determination unit 411c. In FIG. 21 (a) to (d), the horizontal direction of the live view image LV21 displayed by the rear display unit 216 is defined as an X axis and the vertical direction is defined as a Y axis. FIG. 21 (a) illustrates luminance components (brightness) in the X direction near the touched position. FIG. 21 (b) illustrates contrast in the X direction near the touched position. FIG. 21 (c) illustrates luminance components (brightness) in the Y direction near the touched position. FIG. 21 (d) illustrates contrast in the Y direction near the touched position. The curved line Bx indicates variation of the luminance component in the X direction. The curved line CX indicates variation of the contrast in the X direction. The curved line By indicates variation of the luminance component in the Y direction. The curved line Cy indicates variation of the contrast in the Y direction.

As illustrated in FIG. 21 (a) to (d), the area determination unit 411c determines whether or not the touched position is located in an area (R1) sandwiched by two peaks M1 and M2 of contrast on the X axis and the touched position is located in an area (R2) sandwiched by two peaks M3 and M4 of contrast on the Y axis. In the case illustrated in FIG. 21 (a) to (d), the area determination unit 411c determines that the touched position is located in an area sandwiched by peaks of contrast different from each other.

When it is determined that the touched position is located in an area sandwiched by peaks of contrast different from each other by the area determination unit 411c (step S405: Yes), the imaging device 110 proceeds to step S406 described below. On the other hand, when it is determined that the touched position is not in an area sandwiched by peaks of contrast different from each other by the area determination unit 411c (step S405: No), the imaging device 110 proceeds to step S407 described below.

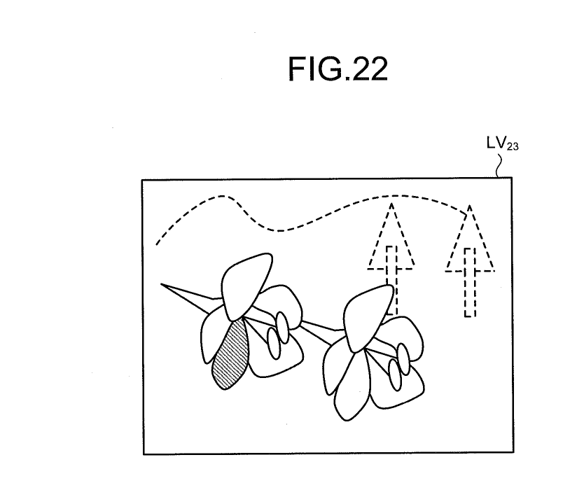

In step S406, the special effect processing unit 207f generates processed image data by executing special effect processing on image data corresponding to the area sandwiched by peaks of contrast different from each other in which the touched position is determined to be located by the area determination unit 411c. Thereby, as illustrated in FIG. 22, the display controller 227b can cause the rear display unit 216 to display the live view image LV23 corresponding to the image data on which the special effect processing is performed by the special effect processing unit 207f. As a result, a user can perform desired special effect processing on an object with no contrast by an intuitive operation. In FIG. 22, the effect of the special effect processing is represented by hatching. After step S406, the imaging device 110 returns to the main routine in FIG. 5. As described above, in this invention, distance distribution of a monotonic portion of relatively low contrast is estimated from transition of distance information of a contour and variation is given to the monotonic portion according to the distance distribution, so that it is possible to effectively obtain a good-looking image. An area whose width gradually reduces in perspective as it approaches the center of the screen is highly probably an area where the distance changes, and the probability can be increased by the distance information of the contour. For more ease, the image processing may be performed by estimating distances from image characteristics in the screen without using the distance information.

When a slide operation is performed on the touch panel 217 in step S407 (S407: Yes), the area determination unit 411c determines whether or not there is an area sandwiched by peaks of contrast different from each other in a slide direction of the slide operation (step S408).

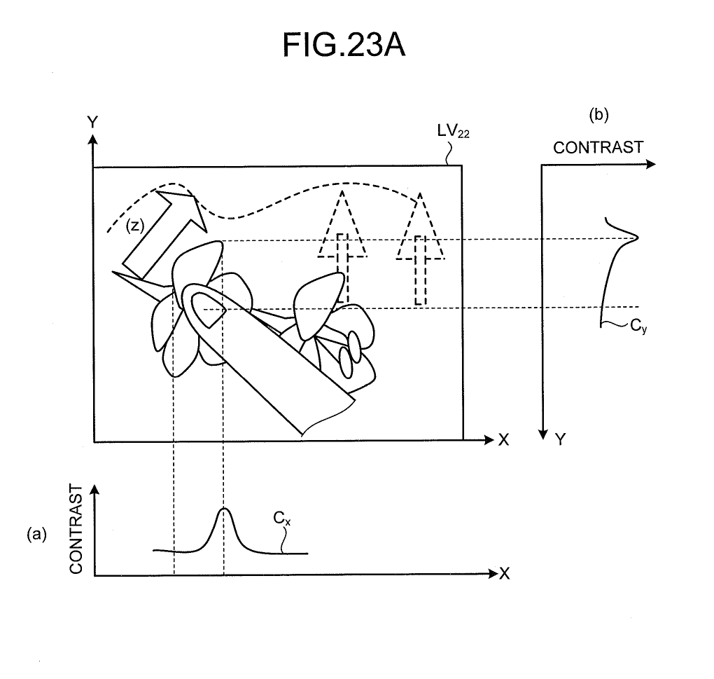

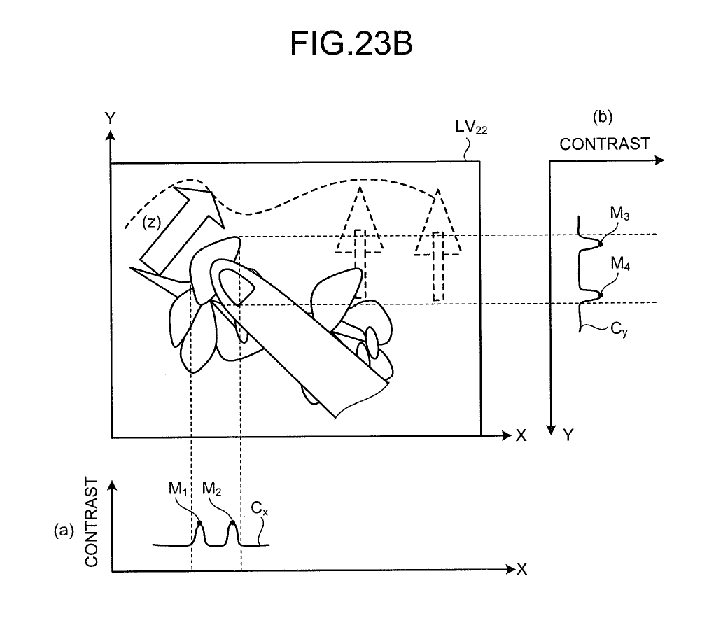

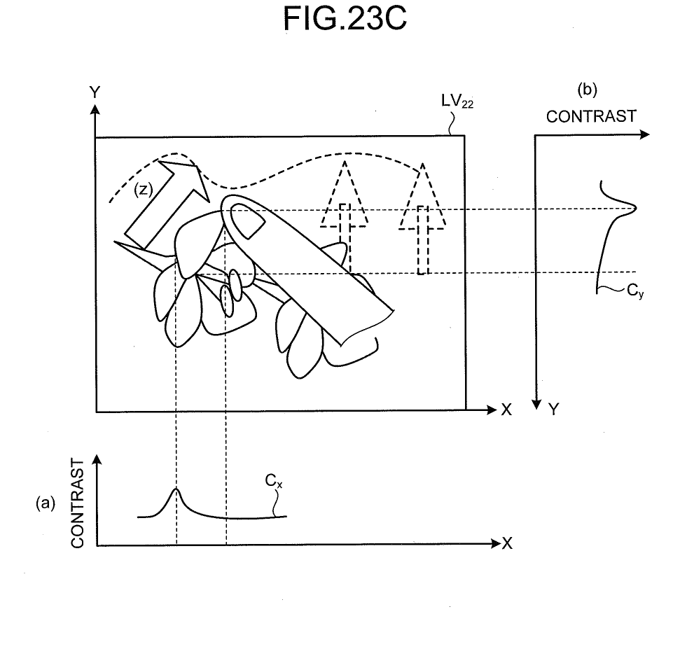

FIGS. 23A, 23B, and 23C are a series of schematic diagrams illustrating an overview of a determination method for determining an area sandwiched by peaks of contrast in the slide direction, by the area determination unit 411c. In FIGS. 23A(a) to (b), 23B(a) to (b), and 23C(a) to (b), the horizontal direction of the live view image LV22 displayed by the rear display unit 216 is defined as an X axis and the vertical direction is defined as a Y axis. FIGS. 23A(a), 23B(a), and 23C(a) illustrate contrast in the X direction at the slide position. FIGS. 23A(b), 23B(b), and 23C(b) illustrate contrast in the Y direction at the slide position. Further, the curved line CX indicates variation of the contrast in the X direction and the curved line Cy indicates variation of the contrast in the Y direction.

As illustrated in FIGS. 23A(a) to (b), 23B (a) to (b), and 23C (a) to (b), the area determination unit 411c determines whether or not there is an area which is sandwiched by two peaks M1 and M2 of contrast on the X axis and sandwiched by two peaks M3 and M4 of contrast on the Y axis along the slide direction (arrow z direction) on the touch panel 217. In the case illustrated in FIGS. 23A(a) to (b), 23B(a) to (b), and 23C(a) to (b), the area determination unit 411c determines that there is an area which is sandwiched by peaks of contrast in the slide direction of the slide operation on the touch panel 217. In this case, the imaging controller 227a causes the focus position of the lens unit 3 to follow in the slide direction by moving the focus lens 307 of the lens unit 3 along the optical axis O on the basis of the locus of the touch position inputted from the touch panel 217.

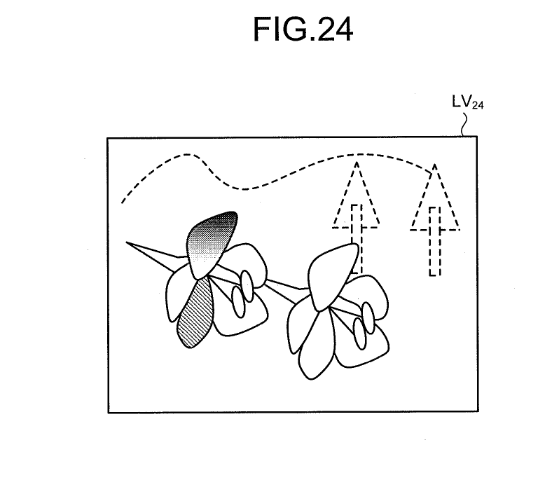

When the area determination unit 411c determines that there is an area which is sandwiched by peaks of contrast different from each other in the slide direction of the slide operation in step S408 (step S408: Yes), the special effect processing unit 207f generates processed image data by executing the special effect processing on image data corresponding to the area determined by the area determination unit 411c (step S409). Thereby, as illustrated in FIG. 24, the display controller 227b can cause the rear display unit 216 to display the live view image LV24 corresponding to the processed image data on which the special effect processing is performed by the special effect processing unit 207f. In FIG. 24, the effect of the special effect processing is represented by hatching. After step S409, the imaging device 110 returns to the main routine in FIG. 5.

When the slide operation is not performed on the touch panel 217 in step S407 (step S407: No), the imaging device 110 returns to the main routine in FIG. 5.

When the area determination unit 411c determines that there is no area which is sandwiched by peaks of contrast different from each other in the slide direction of the slide operation in step S408 (step S408: No), the imaging device 110 returns to the main routine in FIG. 5.

When there is no touch to the touch panel 217 in step S401 (step S401: No), the imaging device 110 returns to the main routine in FIG. 5.

According to the third embodiment of the present invention described above, it is possible to perform image processing different for each distance from the imaging device 110 on an object existing along a direction moving away from the imaging device 110.

Further, according to the third embodiment of the present invention, the special effect processing unit 207f generates processed image data on which the special effect processing is performed for the image data corresponding to an area determined to be an area where the position corresponding to the position signal inputted from the touch panel 217 is sandwiched by peaks of contrast different from each other by the area determination unit 411c, so that, even when an object is captured in a scene with no contrast, it is possible to generate processed image data on which different image processing is performed for each distance from the imaging device 110. Therefore, in a representation of light that changes with distance and a representation of shading, it is possible to create a more artistic representation instead of a solid painted signboard representation. Of course, even a representation like “Cloisonnism” such as Gauguin is artistic. However, to pursue reality, pursuit of the depth feeling is an important representation technique since Renaissance. Further, even in the same color surface, some sort of rhythmic sense, such as painter's brushwork and brush flow, may add energetic feeling to a piece of work, so that the same effect can be expected from the image processing that changes according to a specific rule (here, perspective). In other words, it is possible to obtain a varied and rich image representation power which gives a sense of depth and a rhythmic sense to the screen and effectively uses distance information (need not necessarily be absolute distances, but may be relative perspective information and concave/convex information).

### Fourth Embodiment

Next, a fourth embodiment of the present invention will be described. The imaging device according to the fourth embodiment includes the same configuration as that of the imaging device 110 according to the third embodiment described above and executes distance art processing different from that executed by the imaging device. Therefore, in the description below, the distance art processing executed by the imaging device according to the fourth embodiment will be described. The same components as those in the imaging device 110 according to the third embodiment described above are given the same reference numerals and the description thereof will be omitted.

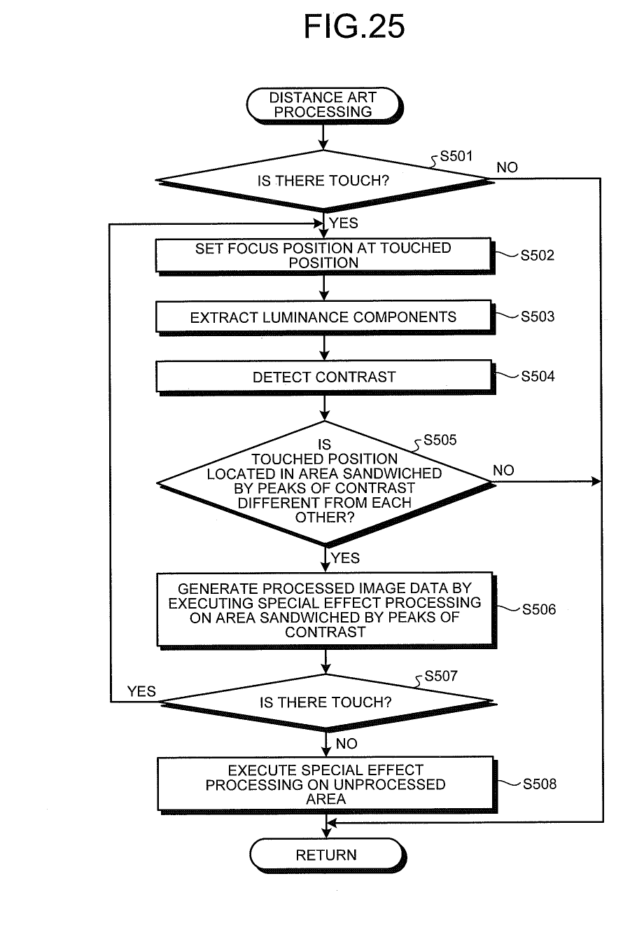

FIG. 25 is a flowchart illustrating an overview of the distance art processing executed by the imaging device 110 according to the fourth embodiment. In FIG. 25, steps S501 to S506 correspond to steps S401 to S406 in FIG. 20, respectively.

When there is a touch to the touch panel 217 in step S507 (step S507: Yes), the imaging device 110 returns to step S502. On the other hand, when there is no touch to the touch panel 217 (step S507: No), the imaging device 110 proceeds to step S508.

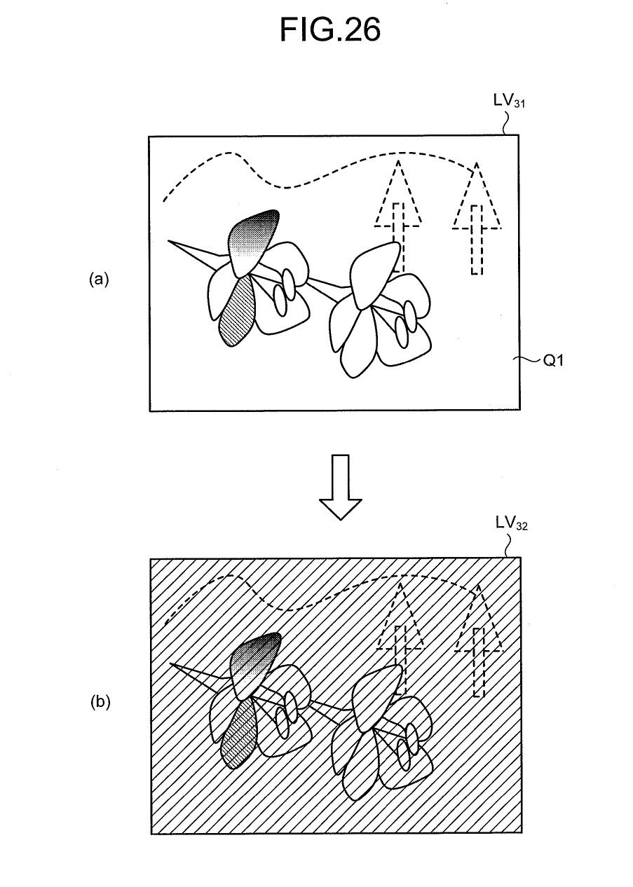

Subsequently, the special effect processing unit 207f executes special effect processing different from that for other areas on an unprocessed area (area on which no image processing is performed) in the processed image corresponding to the processed image data (step S508). Specifically, as illustrated in FIG. 26 (a), the special effect processing unit 207f executes special effect processing different from that for other areas on an unprocessed area Q1 in the processed image LV31 corresponding to the processed image data (FIG. 26 (a)→FIG. 26 (b)). Thereby, as illustrated in FIG. 26 (b), the display controller 227b can cause the rear display unit 216 to display the live view image LV32 corresponding to the processed image data on which the special effect processing is performed by the special effect processing unit 207f. In FIG. 26(a) to (b), the effect of the special effect processing is represented by hatching. After step S508, the imaging device 110 returns to the main routine in FIG. 5.

According to the fourth embodiment of the present invention described above, it is possible to perform image processing different for each distance from the imaging device 110 on an object existing along a direction moving away from the imaging device 110. Therefore, it is possible to perform expressive image processing and image representation which give a sense of depth in the screen and effectively use distance information (need not necessarily be absolute distances, but may be relative perspective information and concave/convex information), and further, it is possible to transmit information to a user by using the image. Further, it is characteristic that user's preference can be directly reflected to an image representation by a touch. An image is divided into areas, and image processing according to position change in the depth direction in the areas is performed.

### Fifth Embodiment

Next, a fifth embodiment of the present invention will be described. In the fifth embodiment, an imaging device has a configuration different from that of the imaging device 1 according to the first embodiment described above and the imaging device executes processing different from that executed by the imaging device. Therefore, in the description below, a configuration of the imaging device according to the fifth embodiment will be described, and then the processing performed by the imaging device according to the fifth embodiment will be described. The same components as those in the imaging device 1 according to the first embodiment described above are given the same reference numerals and the description thereof will be omitted.

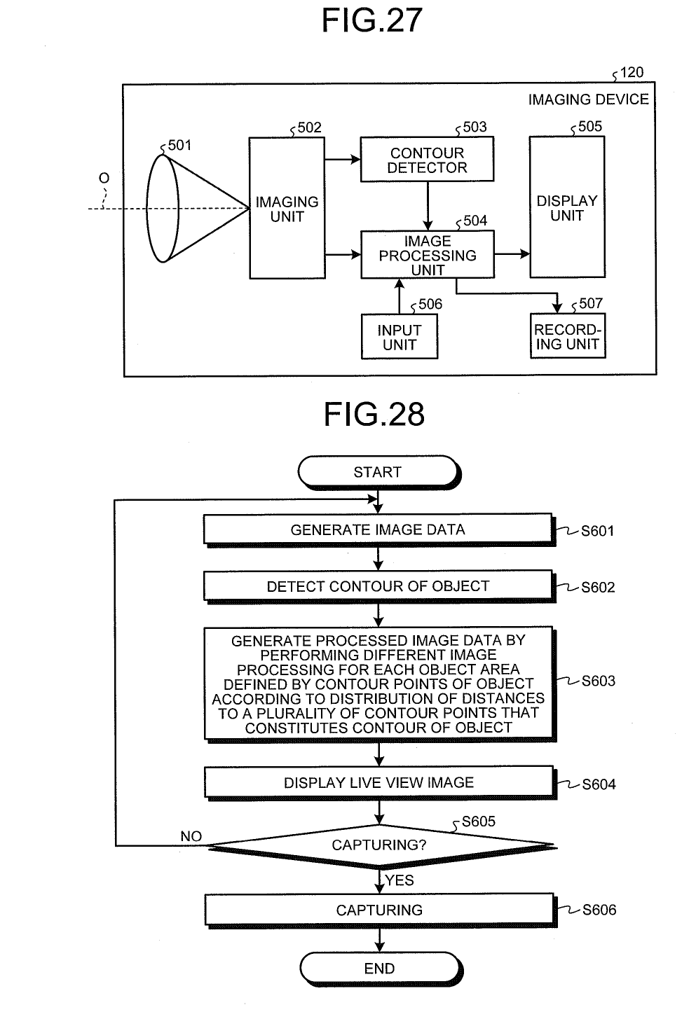

FIG. 27 is a block diagram illustrating a functional configuration of the imaging device according to the fifth embodiment. An imaging device 120 illustrated in FIG. 27 includes a lens unit 501, an imaging unit 502, a contour detector 503, an image processing unit 504, a display unit 505, an input unit 506, and a recording unit 507.

The lens unit 501 is configured by using one or a plurality of lenses, a diaphragm, and the like. The lens unit 501 forms an object image on a light receiving plane of the imaging unit 502.

The imaging unit 502 generates image data of the object by receiving light of the object image formed by the lens unit 501 and performing photoelectric conversion. The imaging unit 502 is configured by using a Charge Coupled Device (CCD) or a CMOS. The imaging unit 502 outputs the image data to the contour detector 503 and the image processing unit 504.

The contour detector 503 detects a contour of the object in an image corresponding to the image data generated by the imaging unit 502. Specifically, the contour detector 503 detects a plurality of contour points that constitutes the contour (contrast) of the object by extracting luminance components of the image data and calculating second derivative absolute values of the extracted luminance components. The contour detector 503 may detect the contour points that constitute the contour of the object by performing edge detection processing on the image data. Further, the contour detector 503 may detect the contour of the object in the image by using a well-known method for the image data.

The image processing unit 504 generates processed image data formed by performing different image processing, for example, image processing whose parameters are changed, for each object area defined by contour points of the object according to distribution of distances from the imaging unit 502 to a plurality of contour points that constitutes the contour of the object detected by the contour detector 503, on the image data generated by the imaging unit 502. In the fifth embodiment, the image processing unit 504 has a function as a special effect processing unit.

The display unit 505 displays an image corresponding to the processed image data generated by the image processing unit 504. The display unit 505 is configured by using a display panel including liquid crystal or organic EL, a driving driver, and the like.

The input unit 506 instructs the imaging device 120 to perform capturing. The input unit 506 is configured by using a plurality of buttons and the like.

The recording unit 507 records the processed image data generated by the image processing unit 504. The recording unit 507 is configured by using a recording medium or the like.

The processing executed by the imaging device 120 having the configuration described above will be described. FIG. 28 is a flowchart illustrating an overview of the processing executed by the imaging device 120.

As illustrated in FIG. 28, first, the imaging unit 502 generates image data (step S601) and the contour detector 503 detects a contour of an object in an image corresponding to the image data generated by the imaging unit 502 (step S602).

Subsequently, the image processing unit 504 generates processed image data by performing different image processing for each object area defined by contour points of the object according to distribution of distances from the imaging unit 502 to a plurality of contour points that constitutes the contour of the object detected by the contour detector 503 on the image data generated by the imaging unit 502 (step S603).

Thereafter, the display unit 505 displays a live view image corresponding to the processed image data generated by the image processing unit 504 (step S604).

Subsequently, when receiving an instruction to perform capturing from the input unit 506 (step S605: Yes), the imaging device 120 performs capturing (step S606). In this case, the imaging device 120 records the processed image data generated by the image processing unit 504 in the recording unit 507. After step S606, the imaging device 120 terminates the processing. On the other hand, when receiving no instruction to perform capturing from the input unit 506 (step S605: No), the imaging device 120 returns to step S601.

According to the fifth embodiment of the present invention described above, it is possible to perform image processing different for each distance from the imaging device 120 on an object existing along a direction moving away from the imaging device 120. Therefore, it is possible to perform expressive image processing and image representation which give a sense of depth in the screen and effectively use distance information, depth information, and concave/convex information, and further, it is possible to transmit information to a user by using the image. In this way, in the present embodiment, it is possible to perform a simple and accurate image representation by collectively determining information of image variation such as a contour obtained from an image (or area division by the information), distance information, and the like. Not only the contour, but also edges of the screen are effectively used.

Further, in the fifth embodiment of the present invention, the image processing unit 504 may generate processed image data by performing different image processing for each object area determined by variation of a distance from the imaging unit 502 to each of a plurality of contour points constituting the contour of the object, which are detected by the contour detector 503. Thereby, it is possible to perform image processing that is changed according to a distance to the object.

Further, in the fifth embodiment of the present invention, the image processing unit 504 may generate processed image data by performing different image processing for each object area determined by the depth from the imaging unit 502 to each of a plurality of contour points constituting the contour of the object, which are detected by the contour detector 503. Here, the depth is a direction moving away from the imaging device 120 in the visual field of the imaging device 120. Thereby, it is possible to perform image processing that is changed according to a distance to the object.

### Other Embodiments

The imaging device according to the present invention can perform an imaging method including a dividing step of dividing an image corresponding to image data generated by an imaging unit into a plurality of areas, an acquisition step of acquiring position change information in a depth direction of each of the plurality of areas divided in the dividing step, and a generation step of generating processed image data by performing image processing according to the position change information acquired in the acquisition step on each of the plurality of areas divided in the dividing step. Here, the position change information is a value (distance information) related to a distance from the imaging device in the visual field of the imaging device, luminance, and contrast. Thereby, it is possible to perform image processing that is changed according to the position change information in the depth direction of the object.

The imaging device according to the present invention can be applied to, for example, a digital camera, a digital video camera, and an electronic device such as a mobile phone with an imaging function and a tablet type portable device with an imaging function, in addition to a digital single lens reflex camera.

A program executed by the imaging device according to the present invention is recorded in a computer-readable recording medium such as a CD-ROM, a flexible disk (FD), a CD-R, a Digital Versatile Disk (DVD), a USB medium, and a flash memory as file data in an installable format or an executable format and provided.

The program executed by the imaging device according to the present invention may be provided by storing the program in a computer connected to a network such as the Internet and downloading the program from the computer through the network. Further, the program executed by the imaging device according to the present invention may be provided or distributed through a network such as the Internet.

In the description of the flowcharts in the present description, the context of the processing of steps is clearly specified by using terms such as “first”, “thereafter”, and “subsequently”. However, the sequence of the processing necessary to implement the present invention is not uniquely determined by these terms. In other words, the sequence of processing in the flowcharts described in the present description can be changed as long as no conflict occurs.

As described above, the present invention may include various embodiments not described here, and various design changes can be made within the scope of the technical ideas specified by the claims.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An imaging device comprising:
an imaging unit configured to image an object and generate image data of the object;
a contour detector configured to detect a contour of the object in an image corresponding to the image data generated by the imaging unit;
a special effect processor configured to generate processed image data that produces a visual effect by performing different image processing for each object area determined by a plurality of contour points that constitutes a contour of the object in accordance with a perspective distribution of the plurality of the contour points that constitutes the contour of the object from the imaging unit, the image processing being performed on an area surrounded by the contour in the image corresponding to the image data generated by the imaging unit.

2. The imaging device according to claim 1, further comprising a distance calculator configured to calculate a value related to a distance from the imaging unit to each one of the contour points constituting the contour of the object, wherein
the special effect processor is configured to generate the processed image data by performing different processing for each object area determined by the calculated value related to the distance to each contour point.

3. The imaging device according to claim 2, further comprising:
a lens unit including an optical system capable of adjusting a focal point; and
a shape determination unit configured to determine whether or not shapes of the object are same with each other along an optical axis in accordance with the contour of the object detected by the contour detector and the value related to the distance calculated by the distance calculator, wherein
the special effect processor is configured to generate the processed image at a time the shape determination unit determines that the shapes of the object are same with each other.

4. The imaging device according to claim 3, wherein
the imaging unit includes:
an imaging pixel generating the image data of the object; and
a focus detection pixel generating focus data for detecting the focal point
the contour detector is configured to detect the contour of the object in accordance with a luminance component included in the image data, and
the distance calculator is configured to calculate the value related to the distance in accordance with the focus data.

5. The imaging device according to claim 1, wherein
the contour detector includes:
a luminance extractor configured to extract a luminance component of the image data;
a contrast detector configured to detect contrast of the image data in accordance with the luminance component extracted by the luminance extractor; and
an area determination unit configured to determine, in an image corresponding to the image data, an area sandwiched by peaks of the contrast different from each other detected by the contrast detector, wherein
the special effect processor is configured to generate the processed image data by performing the imago processing on the area determined by the area determination unit.

6. The imaging unit according to claim 5, further comprising:
a display unit configured to display the image; and
an input unit configured to receive an input of an instruction signal instructing a predetermined position in the image, wherein
the area determination unit is configured to determine whether or not a position corresponding to the instruction signal received by the input unit is within the area.

7. The imaging unit according to claim 6, further comprising:
a lens unit including an optical system capable of adjusting a focal point; and
a imaging controller configured to change the focal point by moving the optical system along an optical axis of the optical system, wherein the input unit is a touch panel provided to be superimposed on a display screen of the display unit and configured to detect touch from an outside and to receive an input of a positional signal corresponding to a position of the detected touch,
the imaging controller is configured to change the focal point by moving the optical system in accordance with change in the positional signal input from the touch panel, and
the area determination unit is configured to determine whether or not a position corresponding to the instruction signal is within the area at a time the optical system moves.

8. The imaging unit according to claim 4, wherein the special effect processor is configured to generate the processed image data by performing special effect processing data that produces a visual effect by combining a plurality of image processing on the image data.

9. The imaging unit according to claim 8, wherein the plurality of image processing combined in the special effect process is at least one of blurring processing, shading addition processing, noise superimposition processing, chroma change processing, and contrast enhancement processing.

10. The imaging unit according to claim 7, wherein the special effect processor is configured to generate the processed image data by performing special effect processing data that produces a visual effect by combining a plurality of image processing on the image data.

11. The imaging unit according to claim 10, wherein the plurality of image processing combined in the special effect process is at least one of blurring processing, shading addition processing, noise superimposition processing, chroma change processing, and contrast enhancement processing.

12. The imaging unit according to claim 4, wherein the special effect processing unit is configured to generate the processed image data by performing special effect processing which superimposes at least one of text data, graphic data, and symbolic data on the image corresponding to the image data in accordance with each distance from the value related to the distance calculated by the distance calculator.

13. The imaging unit according to claim 7, wherein the special effect processing unit is configured to generate the processed image data by performing special effect processing which superimposes at least one of text data, graphic data, and symbolic data on the image corresponding to the image data in accordance with each distance from the value related to the distance calculated by the distance calculator.

14. An imaging method executed by an imaging device that images an object and generates image data of the object, the method comprising:
detecting a contour of the object in an image corresponding to the image data;
generating processed image data that produces a visual effect by performing different image processing for each object area determined by a plurality of contour points that constitutes a contour of the object in accordance with a perspective distribution of the plurality of the contour points that constitutes the contour of the object from the imaging device, the image processing being performed on an area surrounded by the contour in the image corresponding to the image data.

15. An imaging method executed by an imaging device that images an object and generates image data of the object, the method comprising:
dividing an image corresponding to the image data into a plurality of areas;
acquiring position change information in a depth direction of each of the divided areas; and
generating processed image data by performing image processing in accordance with the acquired position change information on each of the divided areas.

16. A non-transitory computer-readable recording medium with an executable program stored thereon, wherein the program instructs a processor of an imaging device that images an object and generates image data of the object, to perform:
detecting a contour of the object in an image corresponding to the image data;
generating processed image data that produces a visual effect by performing different image processing for each object area determined by a plurality of contour points that constitutes a contour of the object in accordance with a perspective distribution of the plurality of the contour points that constitutes the contour of the object from the imaging device, the image processing being performed on an area surrounded by the contour in the image corresponding to the image data.
